(19) United States
(12) Patent Application Publication
(10) Pub. No.: US 2024/0369794 A1
(43) Pub. Date: Nov. 7, 2024

(54) OPTICAL FIBER DISTRIBUTION SYSTEM

(71) Applicant: CommScope Connectivity Belgium BVBA, Kessel-Lo (BE)

(72) Inventors: Johan GEENS, Bunsbeek (BE); Kristof VASTMANS, Boutersen (BE); Eric Marcel M. KEUSTERMANS, Houwaart (BE); Pieter VERMEULEN, Westerlo (BE); Bart VOS, Geel (BE); Dirk Jozef G. VAN DE WEYER, Beringen (BE); Lukas Desmond Elias VAN CAMPENHOUT, Kessel-Lo (BE); Yves PEETERS, Langdorp (BE); Matthias Cyriel George Corneel ALDERWEIRELDT, Kortssem (BE)

(73) Assignee: CommScope Connectivity Belgium BVBA, Kessel-Lo (BE)

(21) Appl. No.: 18/679,764

(22) Filed: May 31, 2024

Related U.S. Application Data
(63) Continuation of application No. 18/190,626, filed on Mar. 27, 2023, now Pat. No. 12,019,300.
Application No. 18/190,626 is a continuation of application No. 17/709,698, filed on Mar. 31, 2022, now Pat. No. 11,614,594.
Application No. 17/709,698 is a continuation of application No. 16/942,085, filed on Jul. 29, 2020, now Pat. No. 11,320,618.
Application No. 16/942,085 is a continuation of application No. 16/178,322, filed on Nov. 1, 2018, now Pat. No. 10,732,373.
Application No. 16/178,322 is a continuation of application No. 15/428,607, filed on Feb. 9, 2017, now Pat. No. 10,126,515.
Application No. 15/428,607 is a continuation of application No. 14/764,486, filed on Jul. 29, 2015, now Pat. No. 9,568,699.
(60) Provisional application No. 61/758,266, filed on Jan. 29, 2013.
(60) Provisional application No. 61/798,256, filed on Mar. 15, 2013.
(60) Provisional application No. 61/815,500, filed on Apr. 24, 2013.
(60) Provisional application No. 61/892,558, filed on Oct. 18, 2013.

(51) Int. Cl. G02B 6/44; G02B 6/38; H04Q 1/02; H04Q 1/06

(52) U.S. Cl. CPC G02B 6/4455; G02B 6/3897; G02B 6/4452; G02B 6/4478; H04Q 1/023; H04Q 1/06

(57) ABSTRACT

An optical fiber distribution system including a rack and elements which populate the rack including fiber terminations. Each element includes a chassis and a movable tray. The movable tray includes a synchronized movement device for moving a cable radius limiter. The tray includes cable terminations which extend in a line generally parallel to a direction of movement of the movable tray. Each of the cable terminations are mounted on hinged frame members positioned on each tray. The cables entering and exiting the movable tray follow a generally S-shaped pathway.

### CROSS-REFERENCE TO RELATED APPLICATIONS

This application is a Continuation of U.S. patent application Ser. No. 18/190,626, filed Mar. 27, 2023; which is a Continuation of U.S. patent application Ser. No. 17/709,698, filed Mar. 31, 2022, now U.S. Pat. No. 11,614,594; which is a Continuation of U.S. patent application Ser. No. 16/942,085, filed on Jul. 29, 2020, now U.S. Pat. No. 11,320,618; which is a Continuation of U.S. patent application Ser. No. 16/178,322, filed on Nov. 1, 2018, now U.S. Pat. No. 10,732,373; which is a Continuation of U.S. patent application Ser. No. 15/428,607, filed on Feb. 9, 2017, now U.S. Pat. No. 10,126,515; which is a Continuation of U.S. patent application Ser. No. 14/764,486, filed Jul. 29, 2015, now U.S. Pat. No. 9,568,699; which is a National Stage Application of PCT/EP2014/051714, filed Jan. 29, 2014; which claims benefit of U.S. Provisional Ser. No. 61/758,266, filed Jan. 29, 2013; U.S. Provisional Ser. No. 61/798,256, filed Mar. 15, 2013; U.S. Provisional Ser. No. 61/815,500, filed Apr. 24, 2013; and U.S. Provisional Ser. No. 61/892,558, filed Oct. 18, 2013, and which applications are incorporated herein by reference. To the extent appropriate, a claim of priority is made to each of the above disclosed applications.

### FIELD OF THE INVENTION

The present invention relates to an optical fiber distribution system, including a rack, and elements which populate the rack, including fiber terminations, patching, fiber splitters, and fiber splices.

### BACKGROUND OF THE INVENTION

Optical fiber distribution systems include fiber terminations and other equipment which is typically rack mounted. Various concerns exist for the optical fiber distribution systems, including density, ease of use, and cable management. There is a continuing need for improvements in the optical fiber distribution area.

### SUMMARY OF THE INVENTION

One implementation of a system in accordance with the examples of the disclosure includes a building block element mountable to a rack or other structure. The element includes a chassis and a movable tray. The tray is movably mounted to the chassis with a slide mechanism that allows the tray to slide relative to the chassis. The slide mechanism includes a synchronized movement feature for managing the cables extending to and from the tray, such that cable pull at the entry and exit locations is reduced or eliminated as the tray is moved.

One synchronized movement feature includes gears, including a rack and pinion system. Another synchronized movement feature includes wheels and wires.

The tray preferably includes mounting structures for holding cable terminations, splitters, and/or splices. One mounting structure includes an open shaped frame member for connector access. In one example, two frame members are provided, one positioned over the other. For improved access, the frame members are hingedly mounted to the tray. In a termination arrangement, the adapters are arranged so that the connector axes are horizontal and extend in a perpendicular direction to the direction of travel for the tray.

Each frame member can be populated with adapter blocks. Pathways guide cables to the adapter ports of the adapter blocks for fiber optic cables terminated with connectors to be received therein. The cables follow a general S-shaped pathway from a side of each element to the adapter blocks. The S-shaped pathway includes two levels inside of the tray to segregate cables between the two frame members. Various flanges and radius limiters can be provided to assist with cable management.

The elements can be stacked in a column with each tray mounted horizontally, or used in a group or block mounted vertically. In the case of a column of elements, a selected tray is pulled outward to access the desired tray, and then the frame members on the tray can be pivoted as needed.

One side of each element can be for patch cables, and the opposite side can be for cable termination of an incoming cable, such as a distribution cable or a feeder cable. Because of the synchronized movement feature, cables can be secured along the sides of the elements and still allow for sliding movement of the trays without a need for large amounts or any cable slack.

The tray and the frame members allow for easy top and bottom access to connectors on either side of the adapters. Openings are provided in the tray bottom for hand access if desired.

The cable mounts for the distribution cables or feeder cables can be snap mounted to the elements and/or mounted in a longitudinal slide mount, and include strength member clamps and cable clamps.

Groupings of loose cables can be managed with cable wraps or other cable guides such as flexible troughs.

The elements can be configured as desired and form building blocks for an optical fiber distribution system (ODF).

When the elements are mounted in a column in a rack, the cables can be placed in vertical cable guides to enter and exit the selected element.

The example rack is front accessible, however, the elements can be used in other racks, frames, cabinets or boxes including in arrangements where rear access is desirable or useful.

### BRIEF DESCRIPTION OF THE FIGURES

FIG. 1 is a perspective view of a first embodiment of an optical fiber distribution element in accordance of aspects of the present disclosure.

FIG. 2 is a top view of the element of FIG. 1.

FIG. 3 is a perspective view of the element of FIG. 1 showing the tray pulled forward from the chassis.

FIG. 4 shows one of the tray frame members pivoted upwardly from the tray.

FIG. 5 shows a second frame member pivoted upwardly relative to the tray.

FIG. 6 shows a portion of a cable management area of the element of FIG. 1.

FIG. 7 shows a similar view to FIG. 6, with one of the frame members pivoted upwardly.

FIG. 8 shows an alternative embodiment of an element with different cable management at the entry points.

FIG. 9 shows three of the elements of FIG. 8 mounted in a block formation, with cable radius limiters at the entry point mounted in an alternative position.

FIG. 10 is a perspective view of the block of FIG. 9.

FIG. 11 is a view of the block of FIG. 9, with the tray of the middle element pulled forward for access to the fiber terminations.

FIG. 12 shows an enlarged portion of an entry point for one of the elements with a cable radius limiter in a first position.

FIG. 13 shows a similar view as in FIG. 12, with the cable radius limiter positioned in an alternate position.

FIG. 14 shows an exploded view of a cable mount.

FIG. 15 shows an element with a cable mount on one side, and a cable radius limiter on an opposite side.

FIG. 16 shows an alternative cable mount.

FIGS. 17-29 show various views of the elements shown in FIGS. 1-16 including additional details and cable routings shown for illustration purposes.

FIG. 30 shows an alternative embodiment of a block of two alternative elements.

FIG. 31 shows a tray pulled forward from the chassis of one of the elements of the block of FIG. 30.

FIG. 32 shows the tray extended forward as in the view of FIG. 31, with one of the frame members pivoted upwardly.

FIG. 33 is a view similar to the view of FIG. 32, with a second frame member pivoted upwardly.

FIG. 34 shows a block including two elements.

FIG. 35 shows an exploded view of the two elements of the block of FIG. 34.

FIG. 36 shows a single element.

FIG. 37 shows an exploded view of the element of FIG. 36.

FIG. 38 shows the element of FIG. 37, without the top cover.

FIG. 39 is a top view of the element of FIG. 38.

FIG. 40 is an alternative view of the element of FIG. 38, showing alternative devices at the cable entry points.

FIG. 41 is a top view of the element of FIG. 40.

FIG. 42 shows an alternative embodiment of an element in a top view with an alternative synchronized movement feature.

FIG. 43 is a perspective view of the element of FIG. 42.

FIGS. 44 and 45 show movement of the various components of the synchronized movement feature of FIGS. 42 and 43.

FIGS. 46 and 47 show an element with an alternative radius limiter at the cable entry and exit locations.

FIGS. 48 and 49 show an element with alternative radius limiters on the slide mechanism.

FIG. 50 shows a pair of elements in a stacked configuration, the elements shown with another alternative radius limiter on the slide mechanism.

FIG. 51 is a top view of one of the elements of FIG. 50 illustrating the alternative radius limiter.

### DETAILED DESCRIPTION

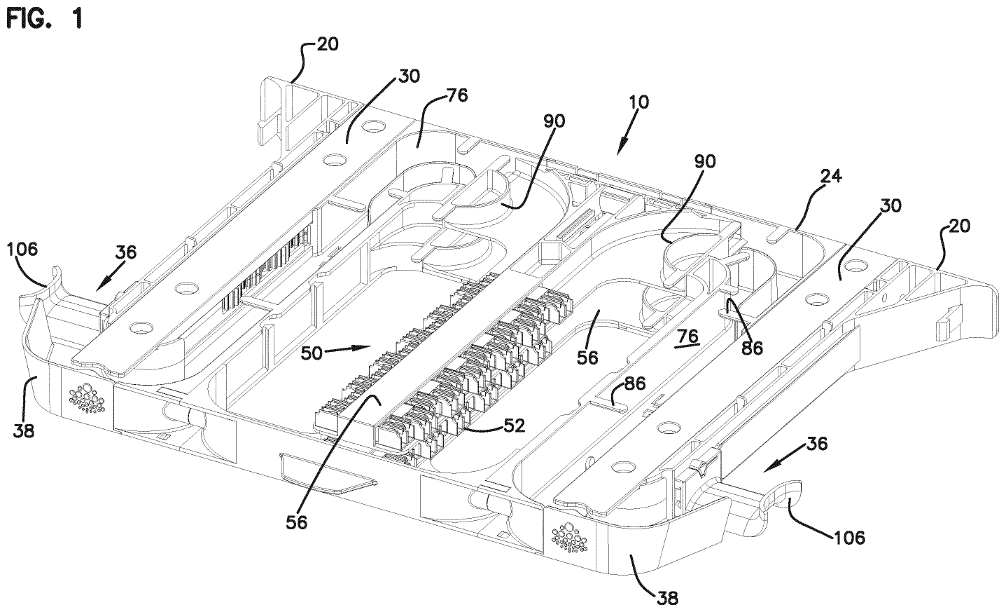

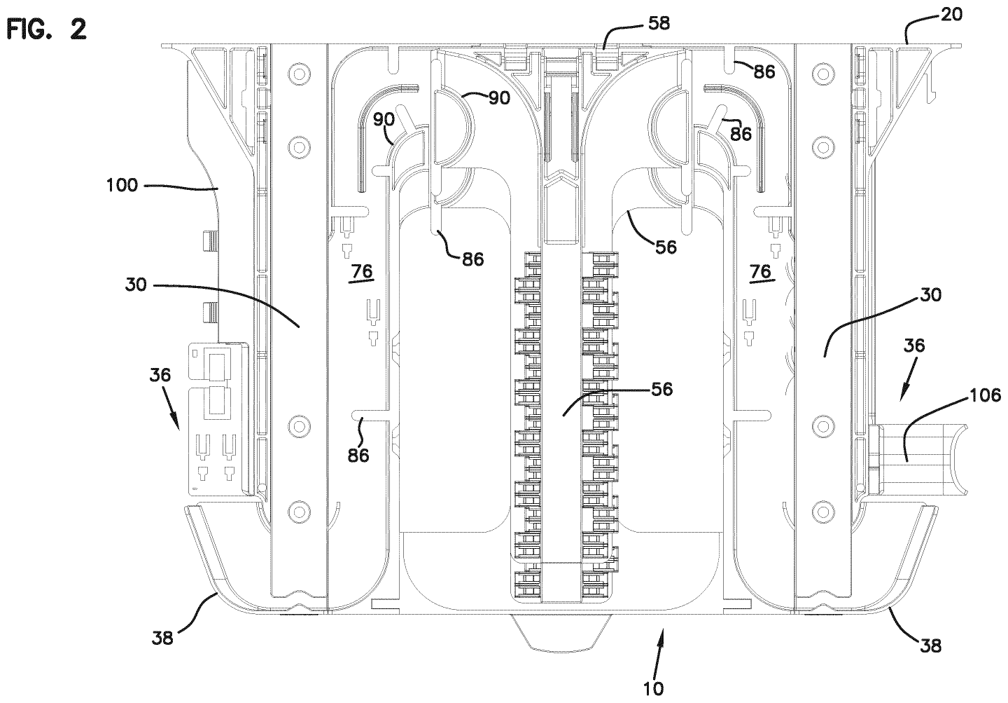

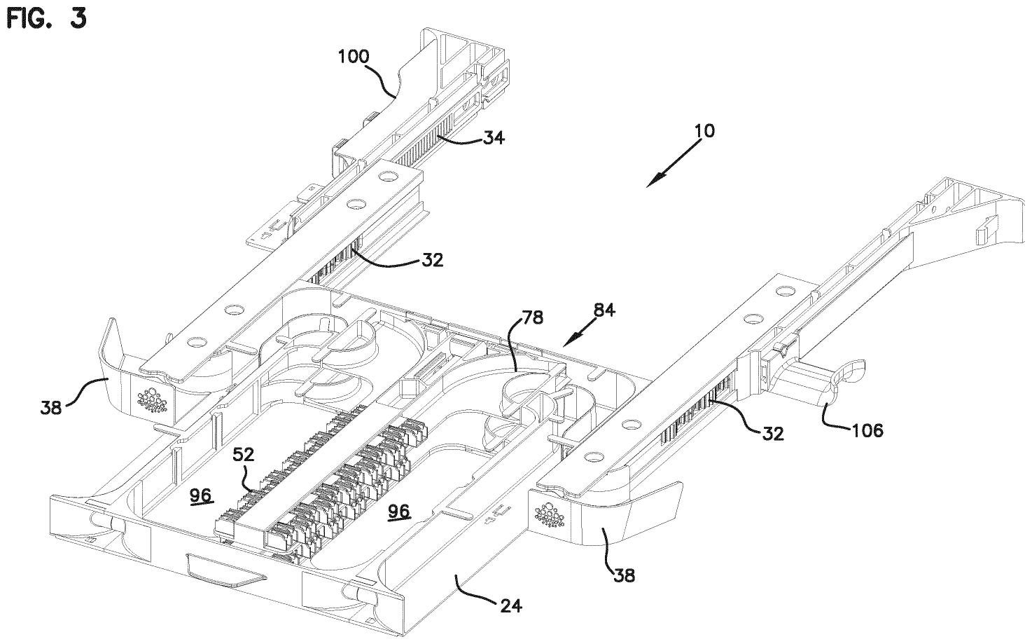

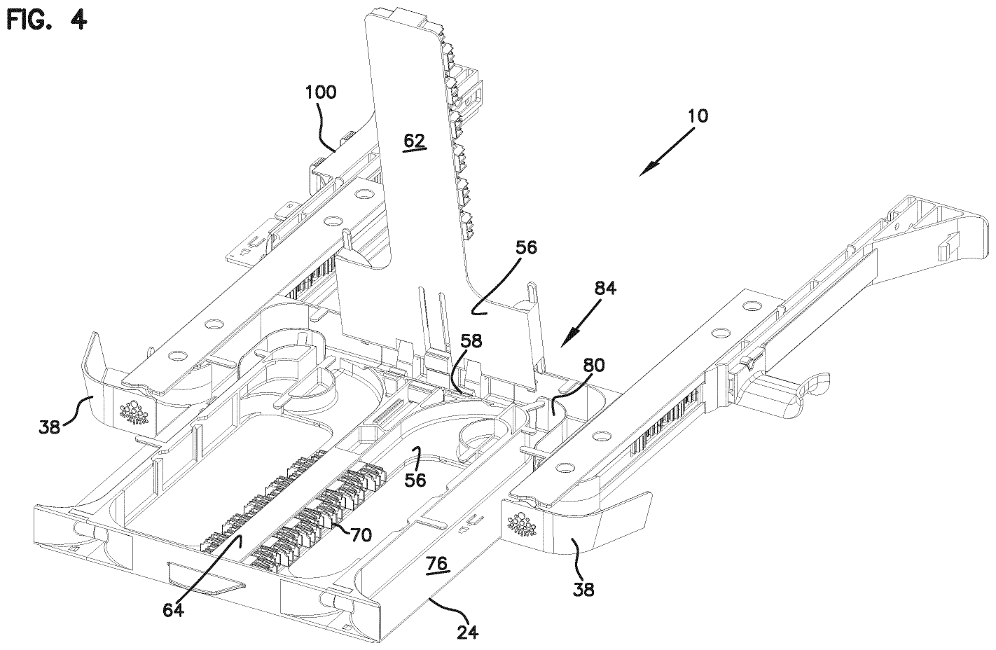

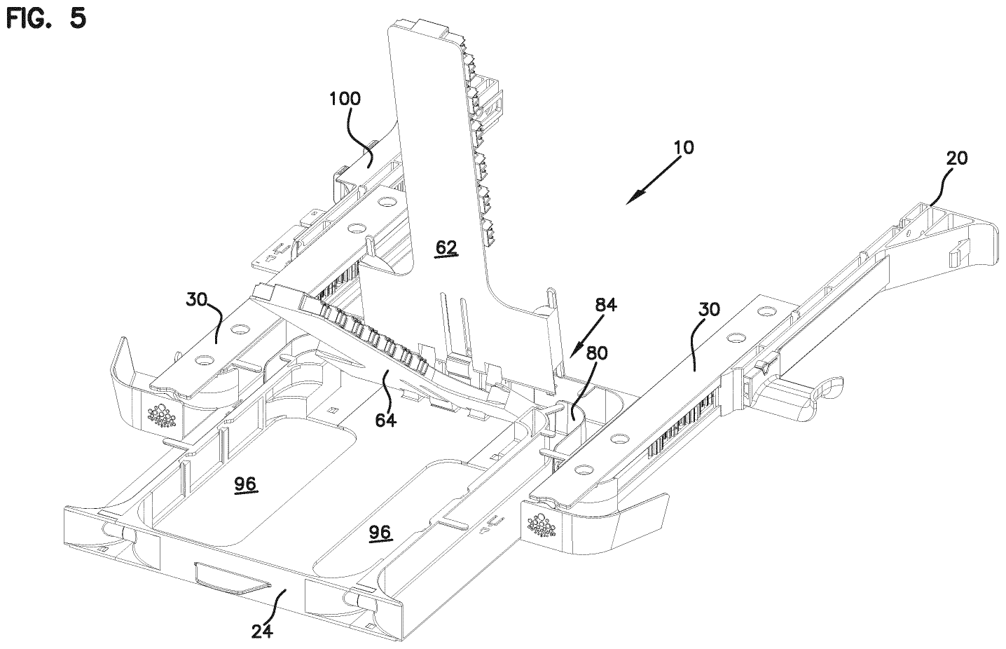

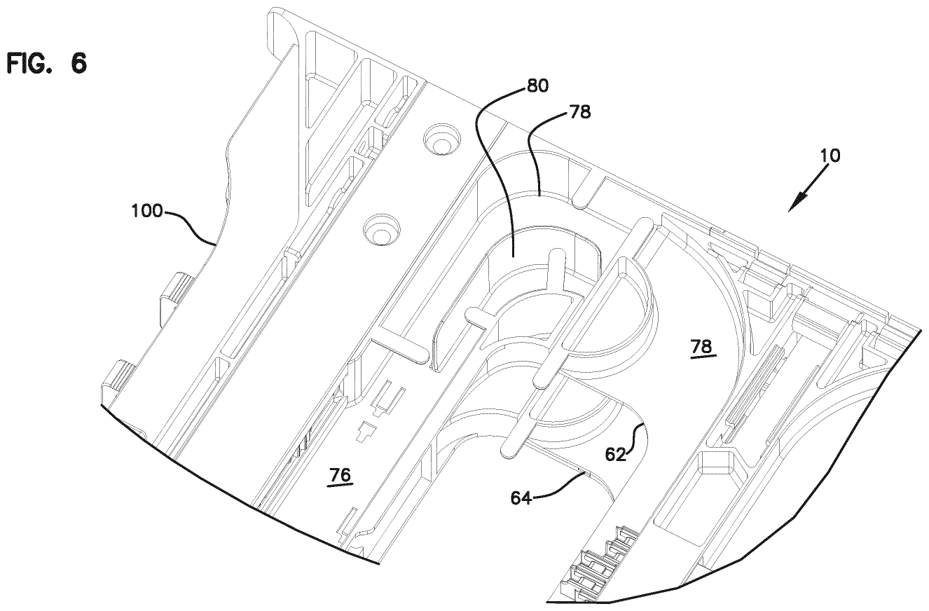

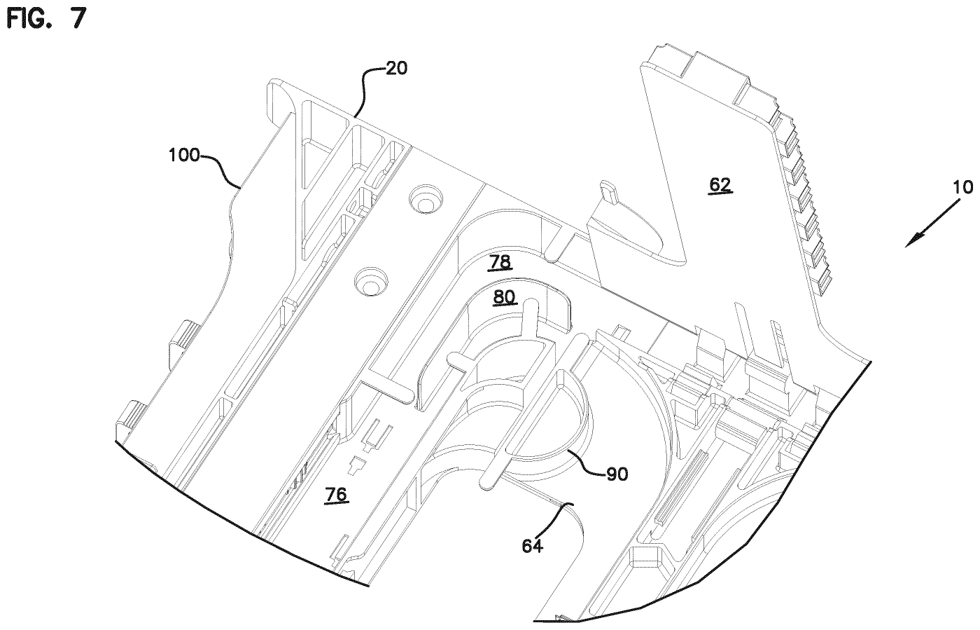

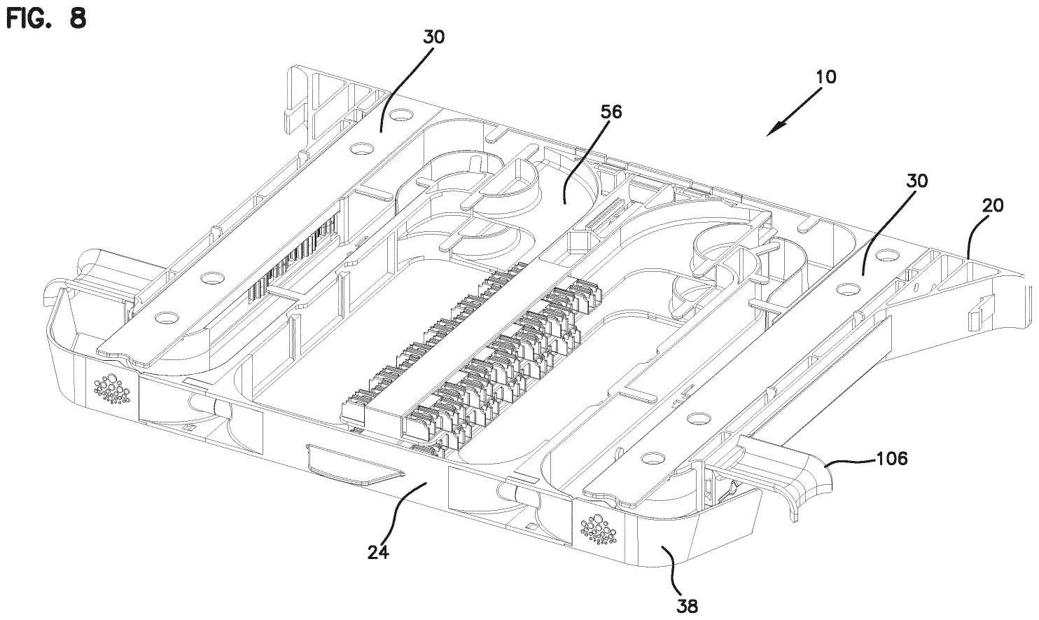

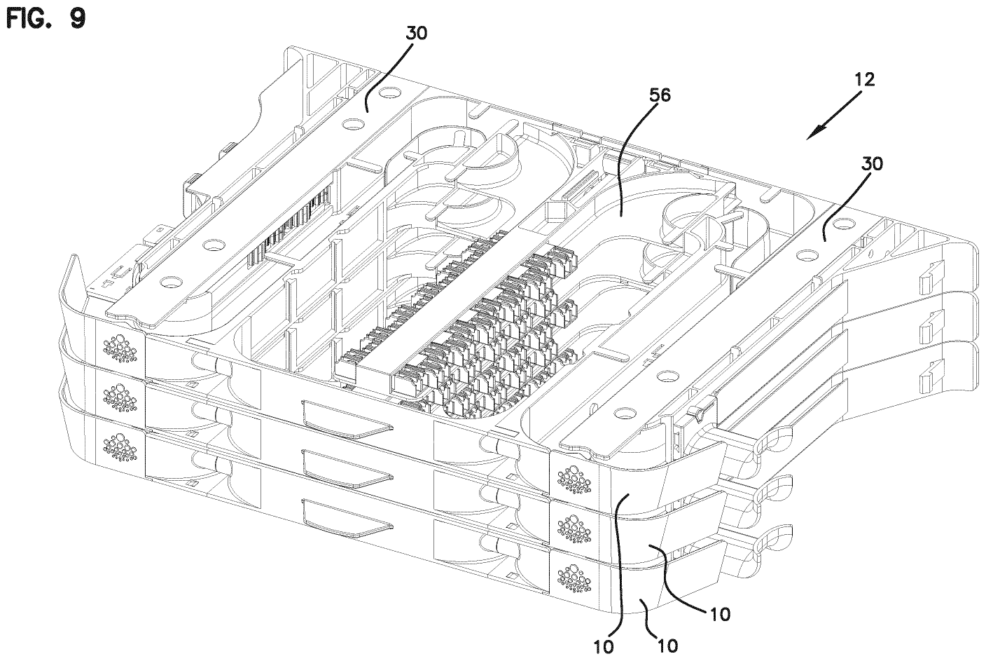

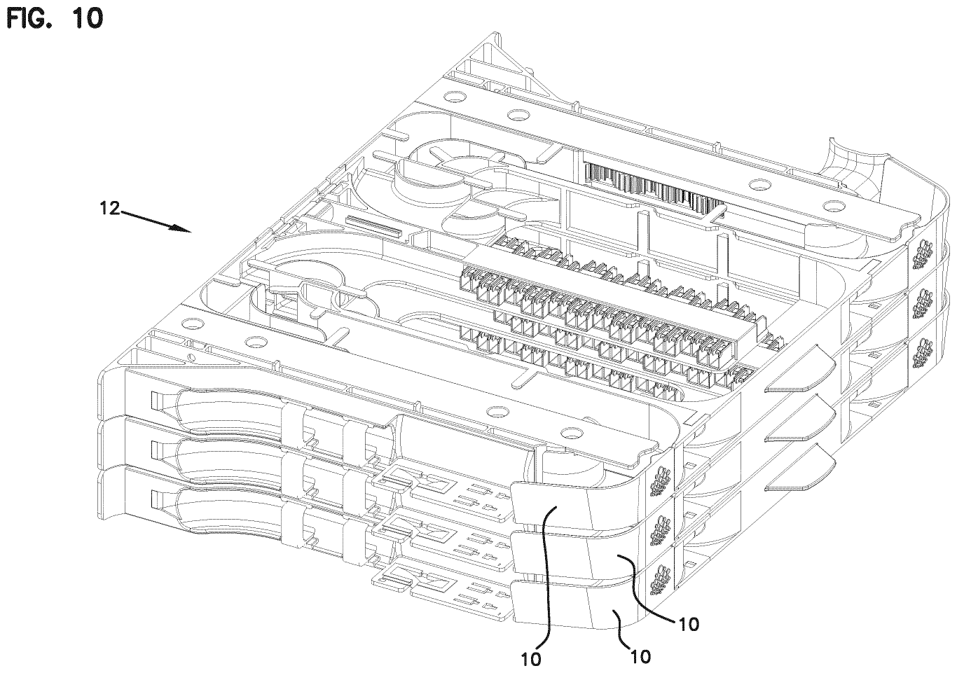

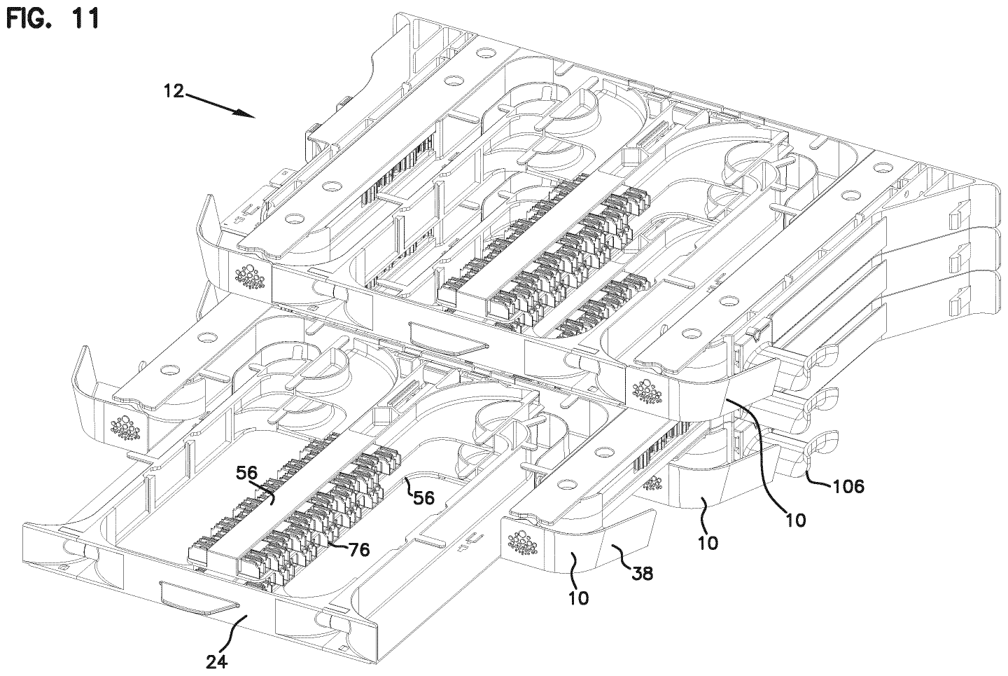

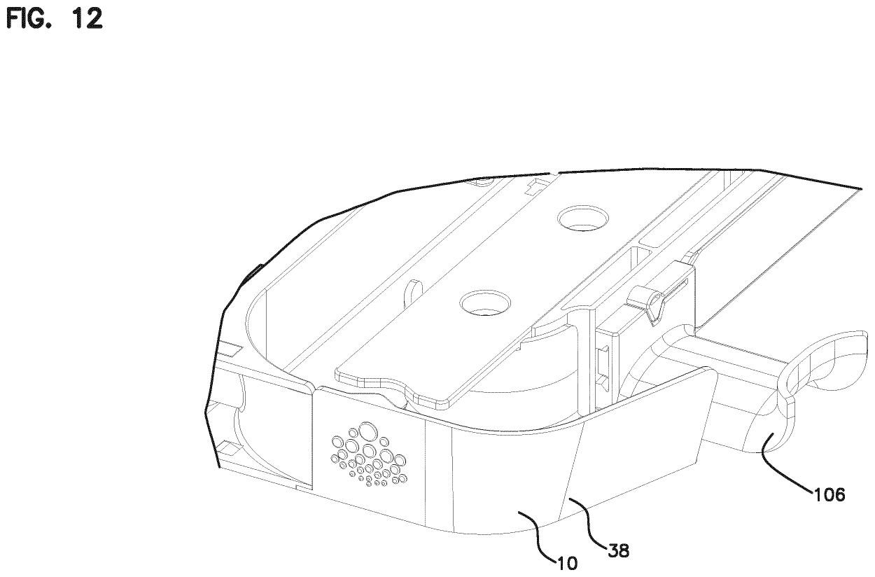

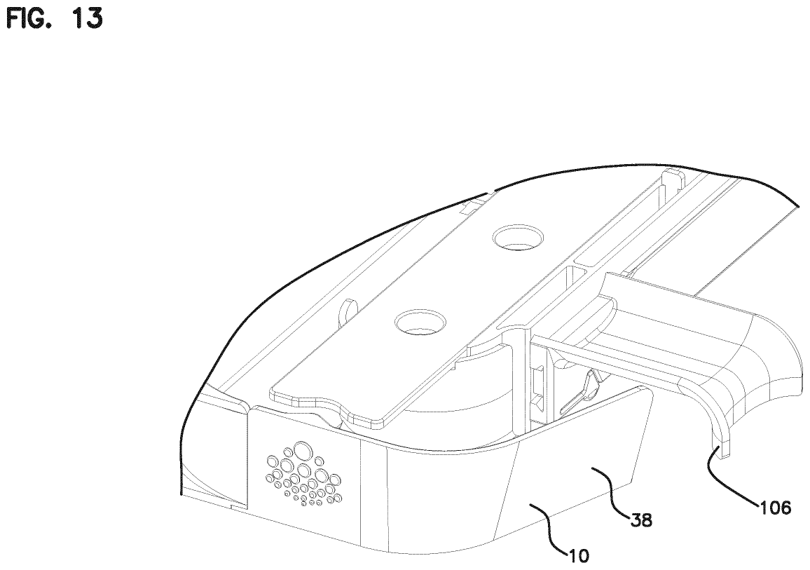

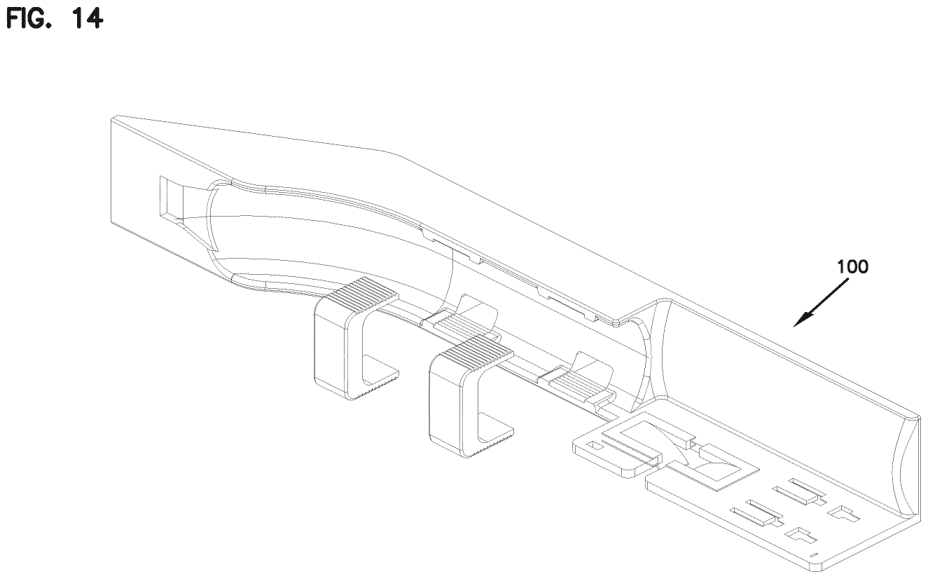

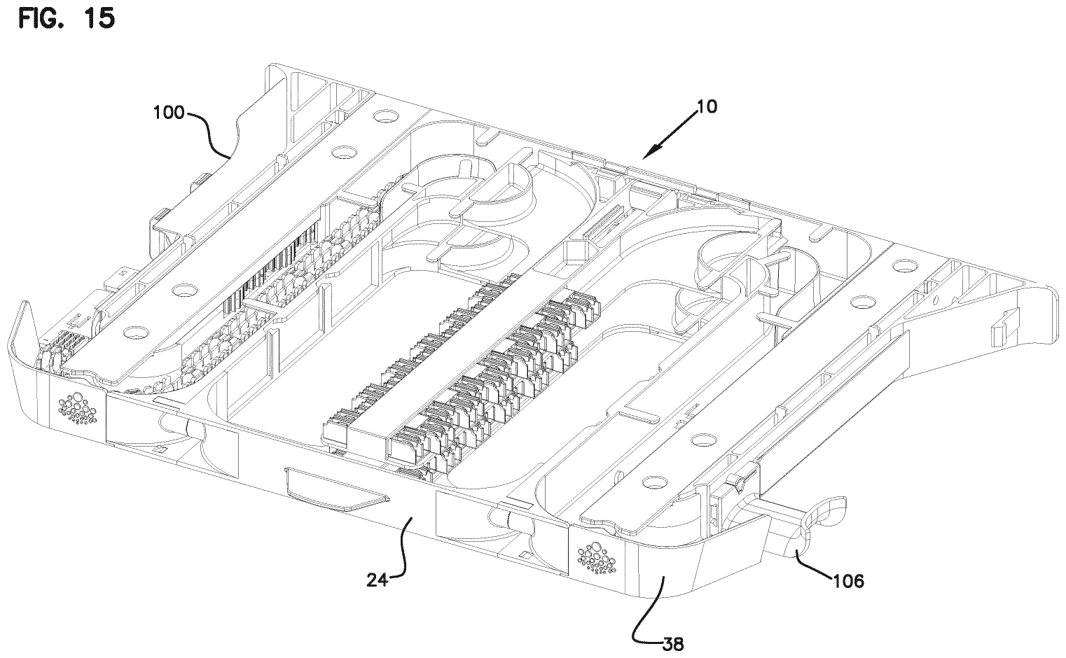

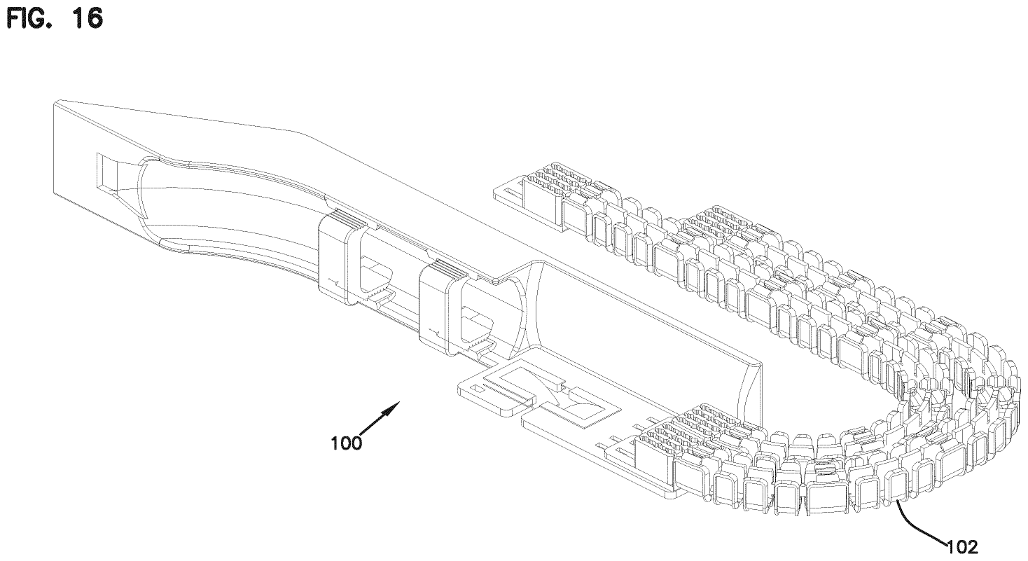

Referring now to FIGS. 1-16, various embodiments of an optical fiber distribution element 10, or element 10, are shown. The elements 10 can be individually mounted as desired to telecommunications equipment including racks, frames, or cabinets. The elements 10 can be mounted in groups or blocks 12 which forms a stacked arrangement. In one embodiment, a vertical stack of elements 10 populates an optical fiber distribution rack.

Each element 10 holds fiber terminations, or other fiber components including fiber splitters and/or fiber splices. In the case of fiber terminations, incoming cables are connected to outgoing cables through connectorized cable ends which are connected by adapters, as will be described below.

Each element includes a chassis 20 and a movable tray 24. Tray 24 is movable with a slide mechanism 30 including one or more gears 32 and a set of two toothed racks or linear members 34.

Slide mechanism 30 provides for synchronized movement for managing the cables extending to and from tray 24. Entry points 36 on either side of chassis 20 allow for fixation of the input and output cables associated with each element 10. The radius limiters 38 associated with each slide mechanism 30 move in synchronized movement relative to chassis 20 and tray 24 to maintain fiber slack, without causing fibers to be bent, pinched, or pulled.

Each tray 24 includes mounting structure 50 defining one or more of fiber terminations, fiber splitters, fiber splices, or other fiber components. As shown, mounting structure 50 holds adapters 52 which allow for interconnection of two connectorized ends of cables. Each tray 24 includes one or more frame members 56. In the example shown, two frame members 56 are provided. As illustrated, each frame member 56 is T-shaped. Also, each tray 24 includes two frame members 56 which are hingedly mounted at hinges 58. A top frame member 62 is positioned above a bottom frame member 64. The mounting structure 50 associated with each frame member 62, 64 includes one or more integrally formed adapter blocks 70. Adapter blocks 70 include a plurality of adapter ports for interconnecting to fiber optic connectors 72. A pathway 76 defines a generally S-shape from radius limiters 38 to adapter blocks 70. As shown, pathway 76 includes an upper level 78 and a lower level 80 in the interior. A portion 84 of pathway 76 is positioned adjacent to hinges 58 to avoid potentially damaging cable pull during pivoting movement of frame members 56. Flanges 86 and radius limiters 90 help maintain cables 74 in pathways 76.

Tray 24 includes openings 96 to allow for technician access to the cable terminations at adapter blocks 70. In addition, the T-shapes of frame members 56 further facilitate technician access to the connectors 72.

Cables 74 extending to and from clement 10 can be affixed with a cable mount 100 as desired. Additional protection of the fiber breakouts can be handled with cable wraps 102. Radius limiters 106 can be additionally used to support and protect the cables 74.

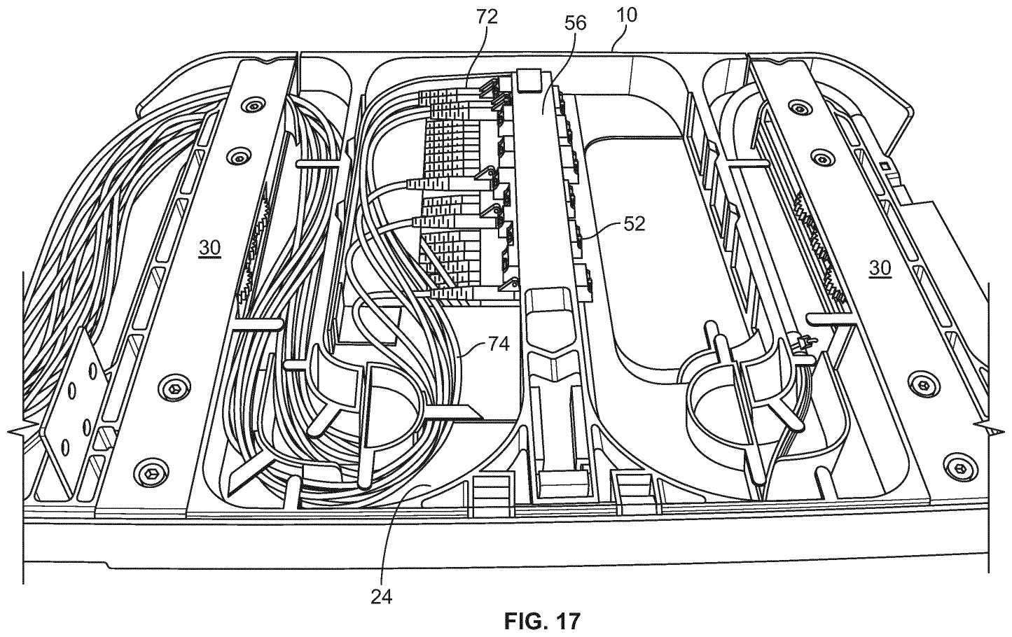

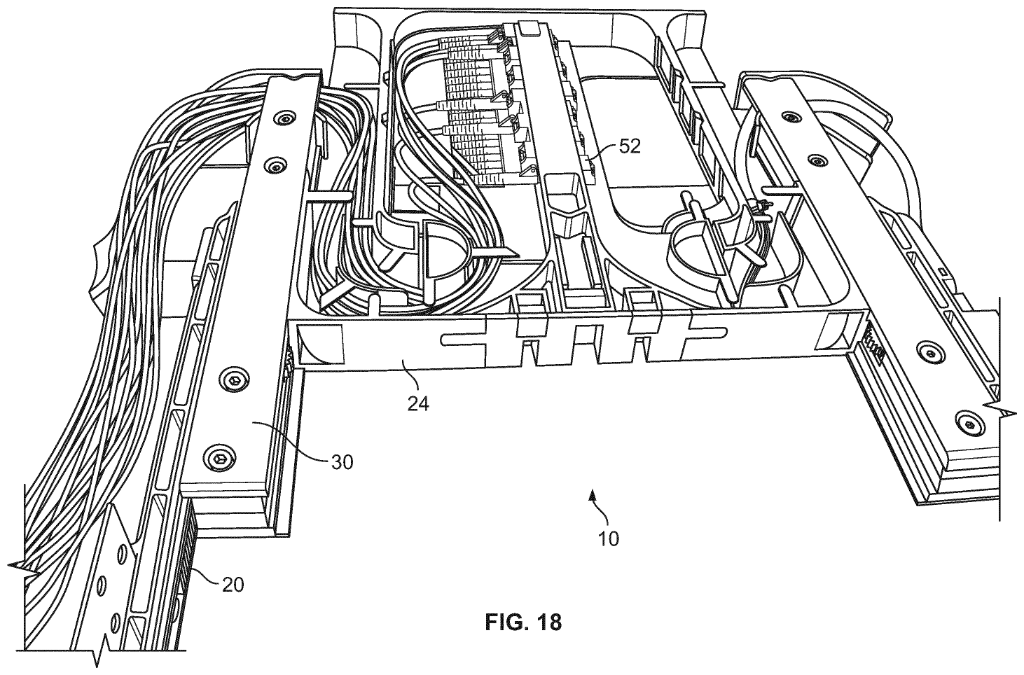

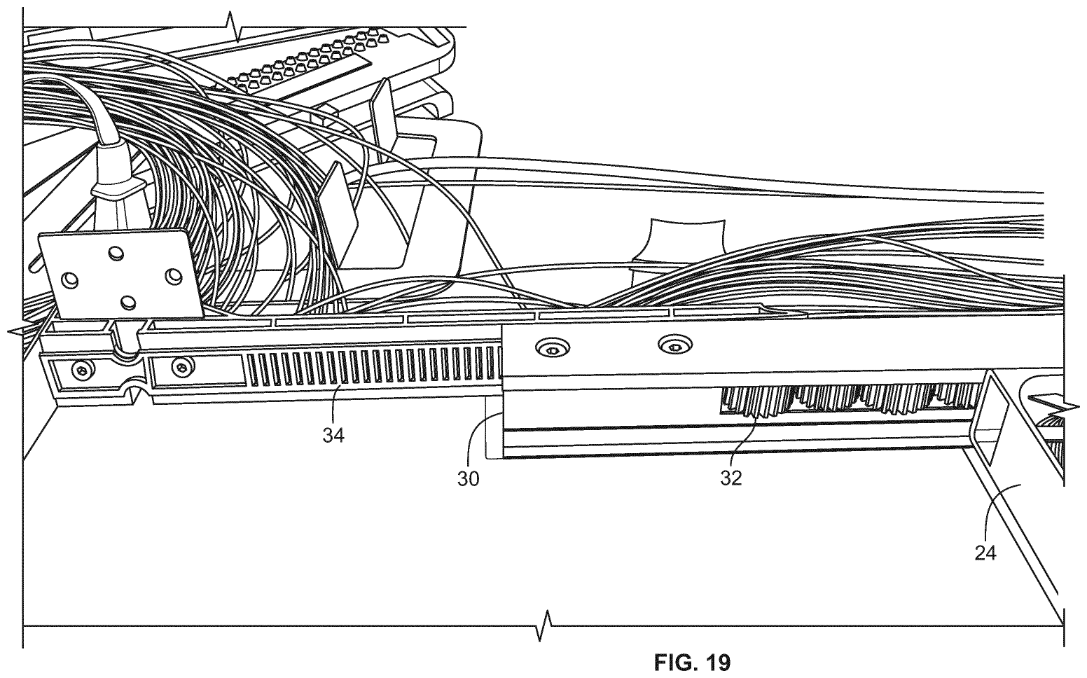

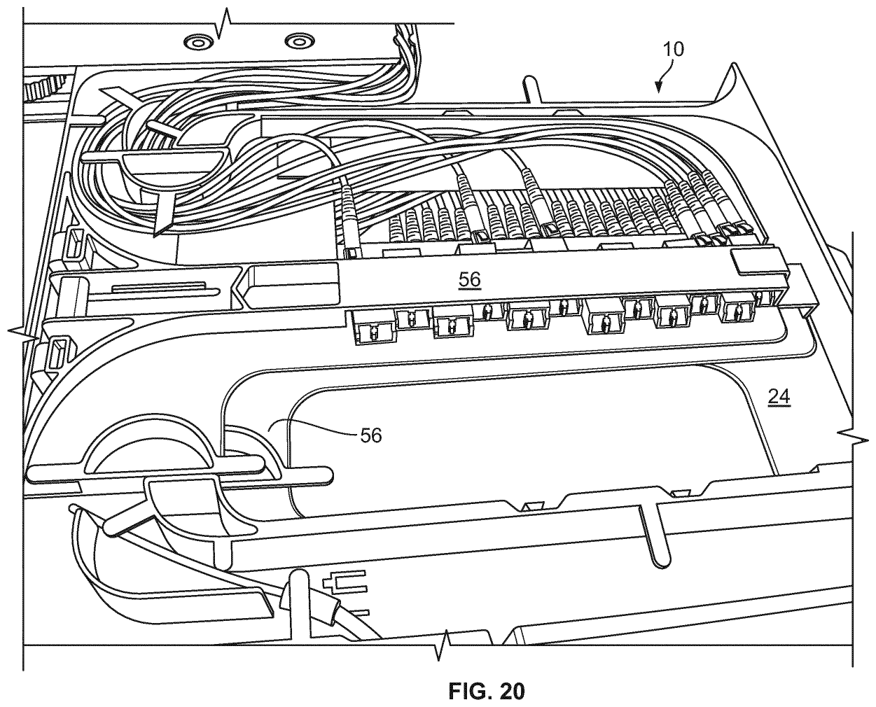

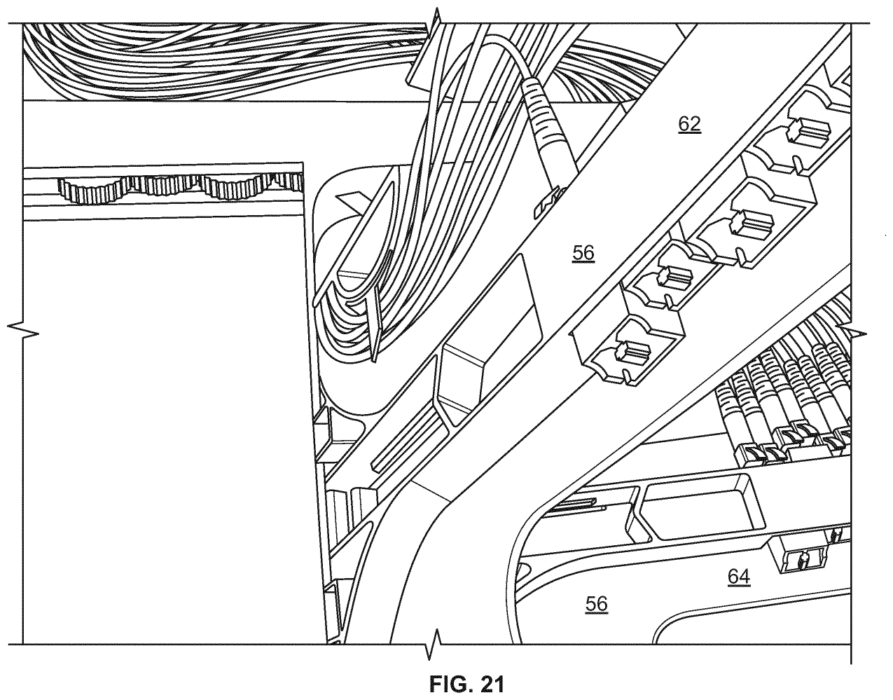

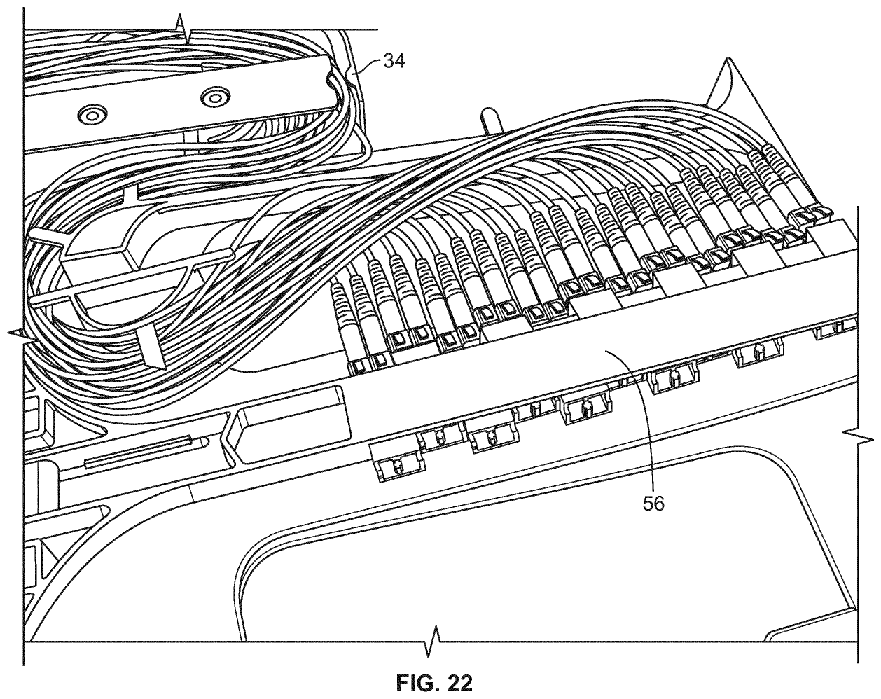

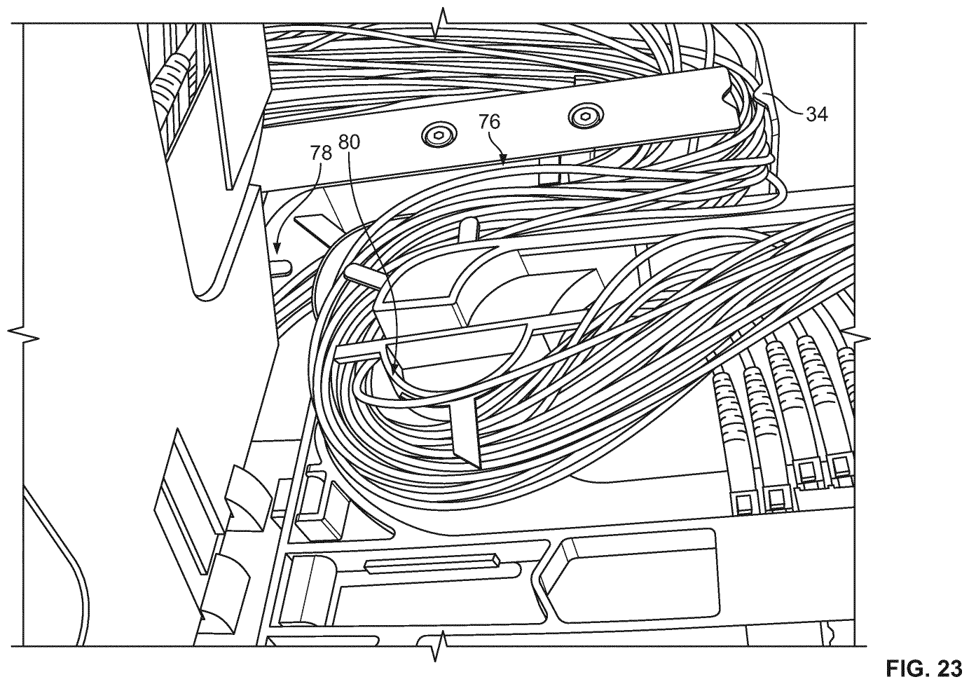

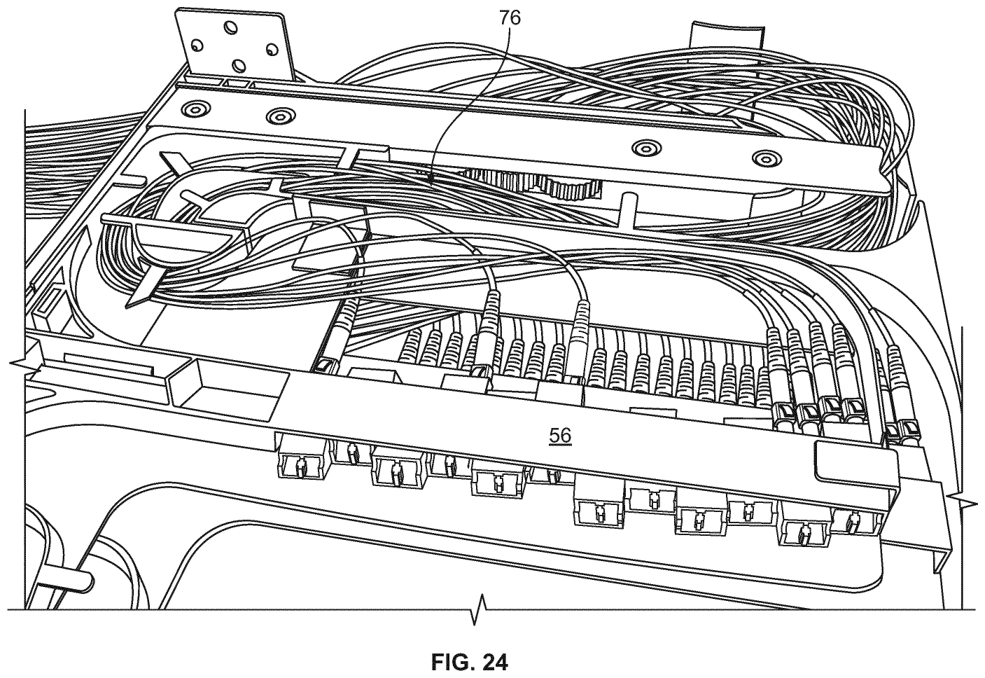

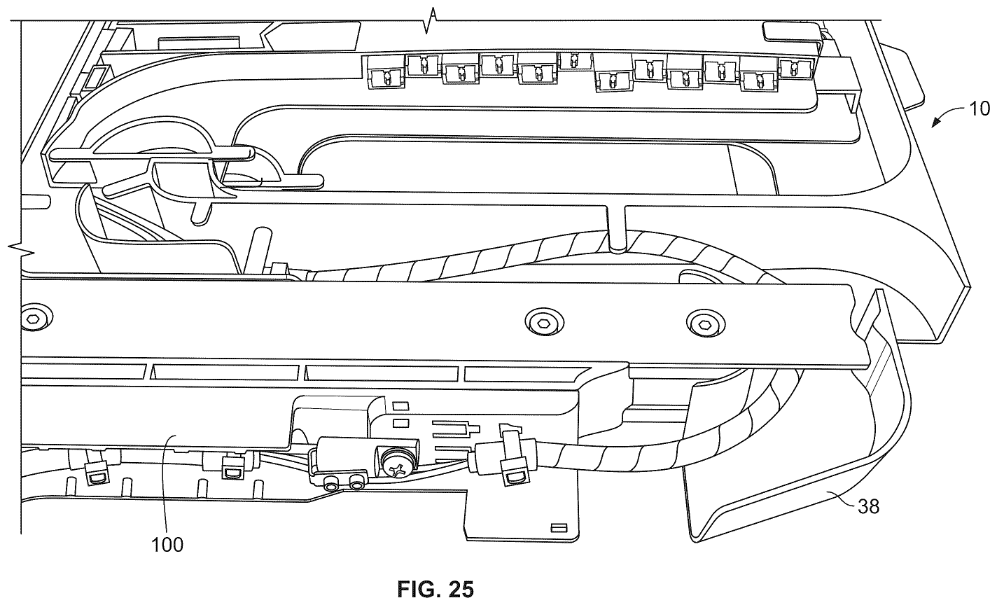

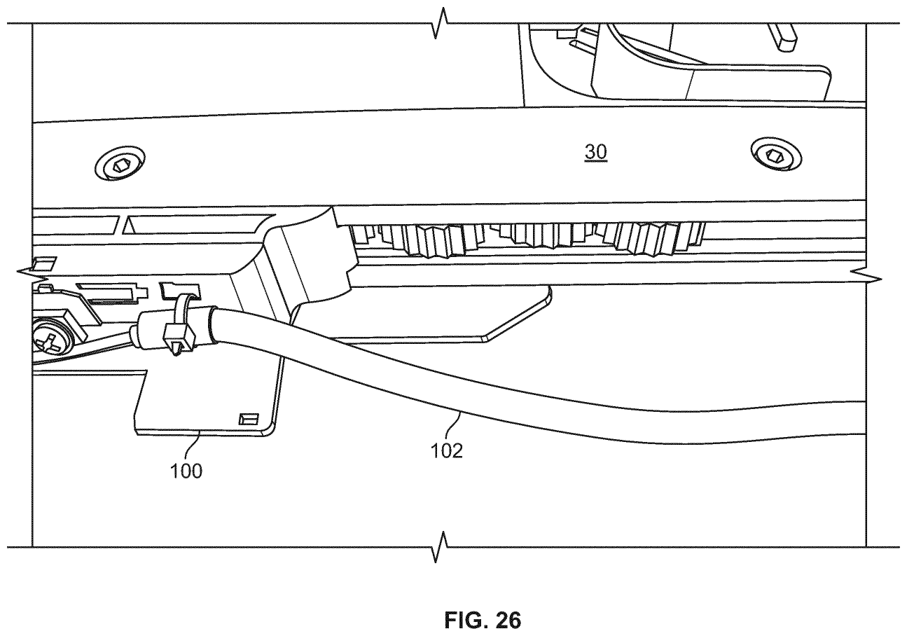

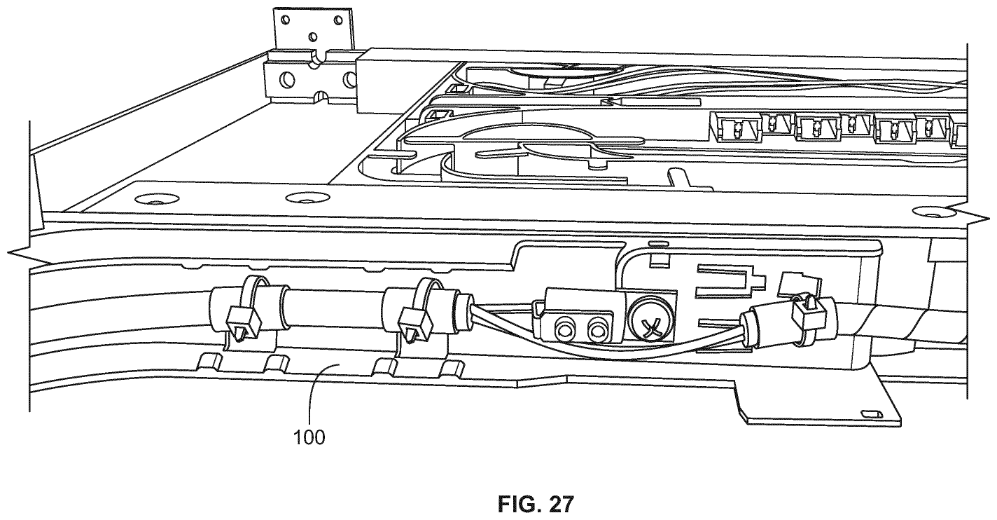

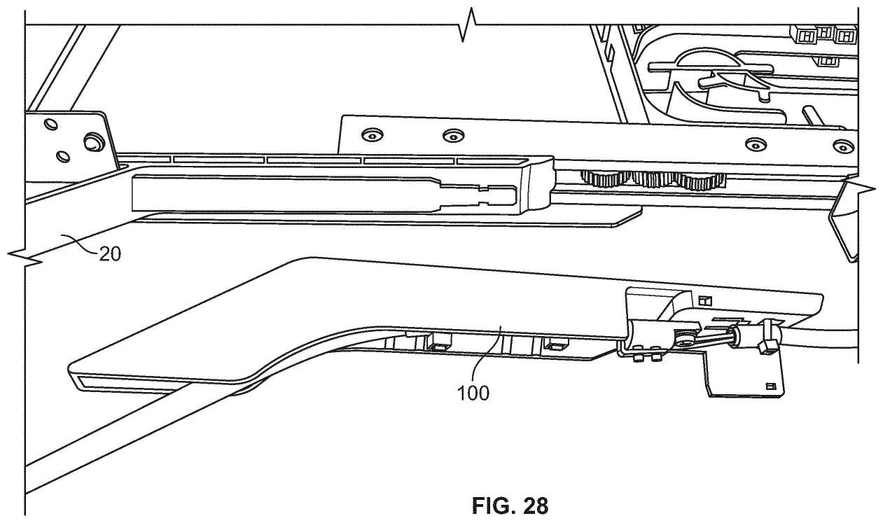

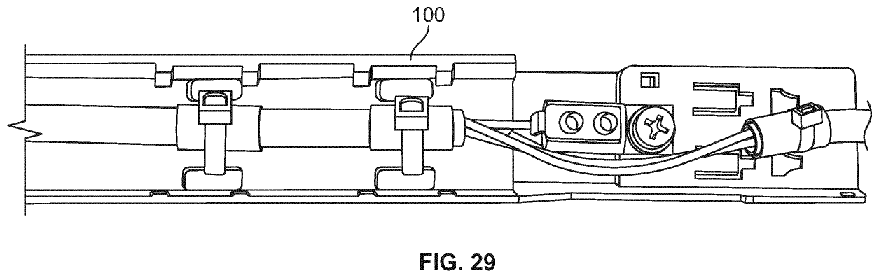

Referring now to FIGS. 17-29, various examples of cable routings are illustrated for element 10.

If desired, more than one feeder cable can supply cabling to more than one element 10.

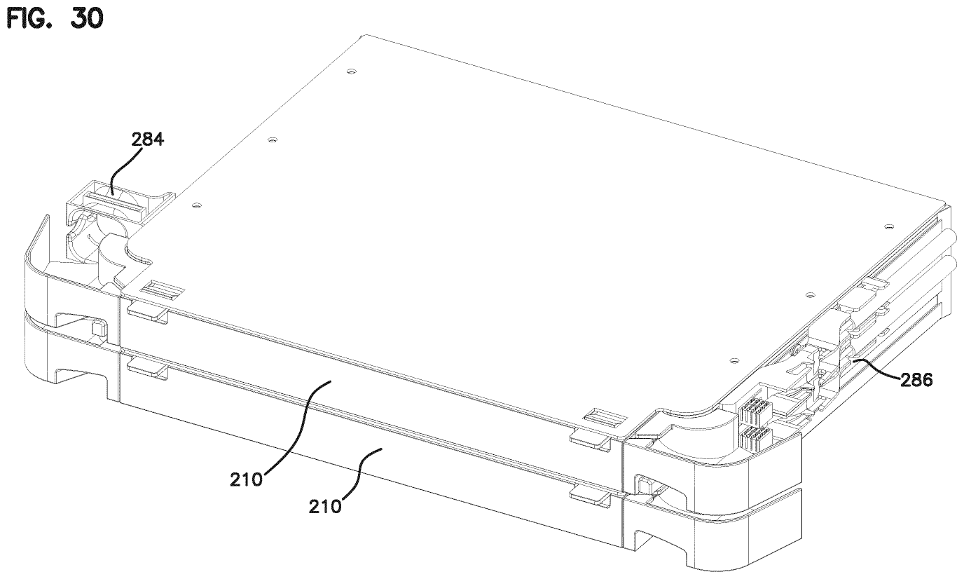

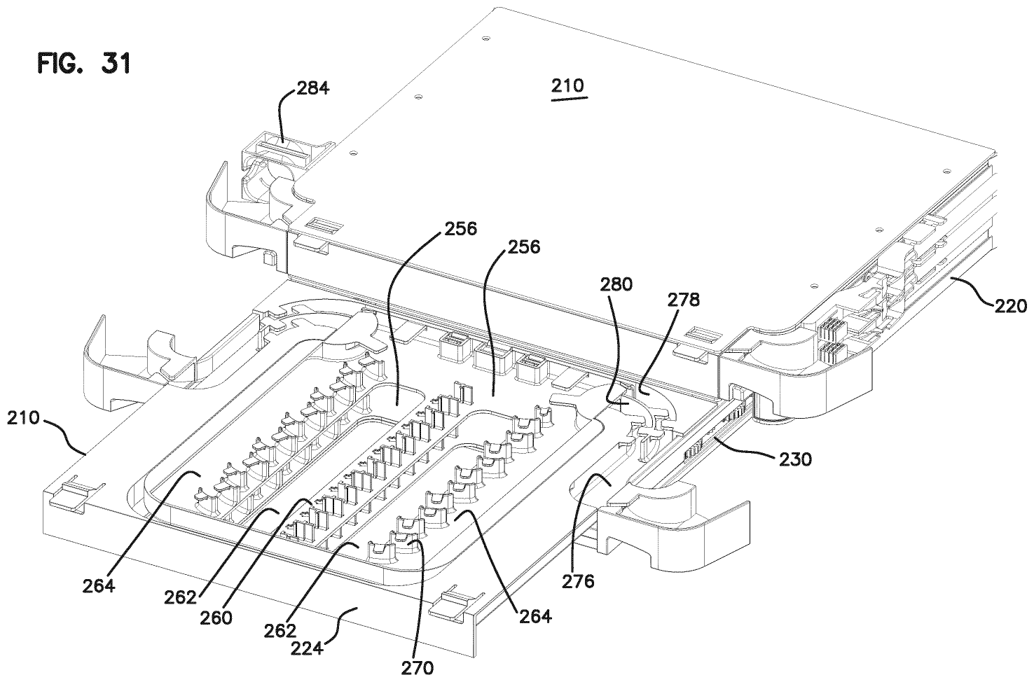

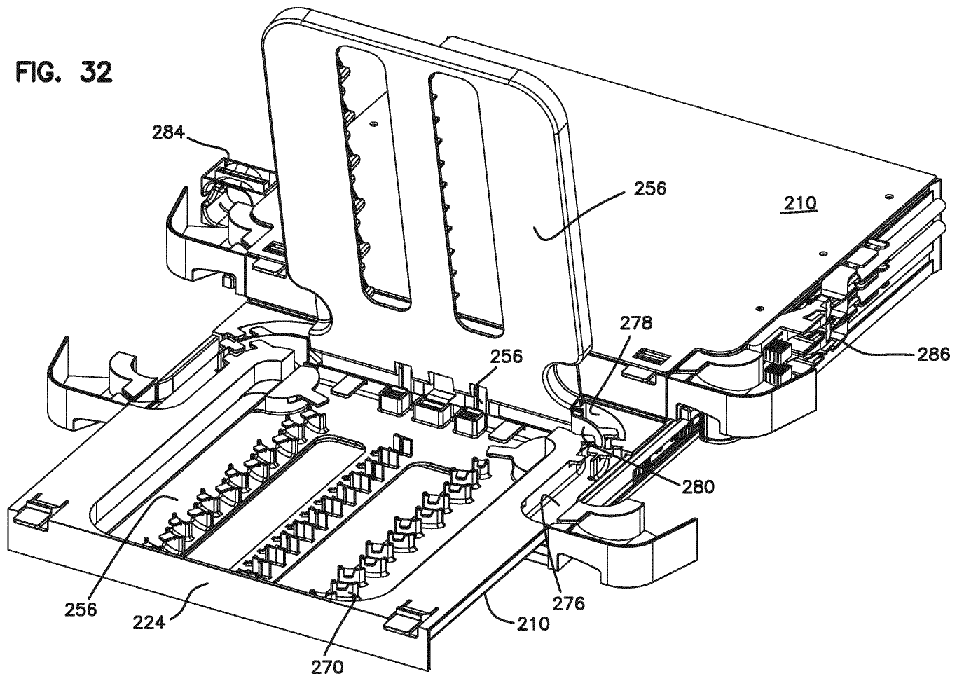

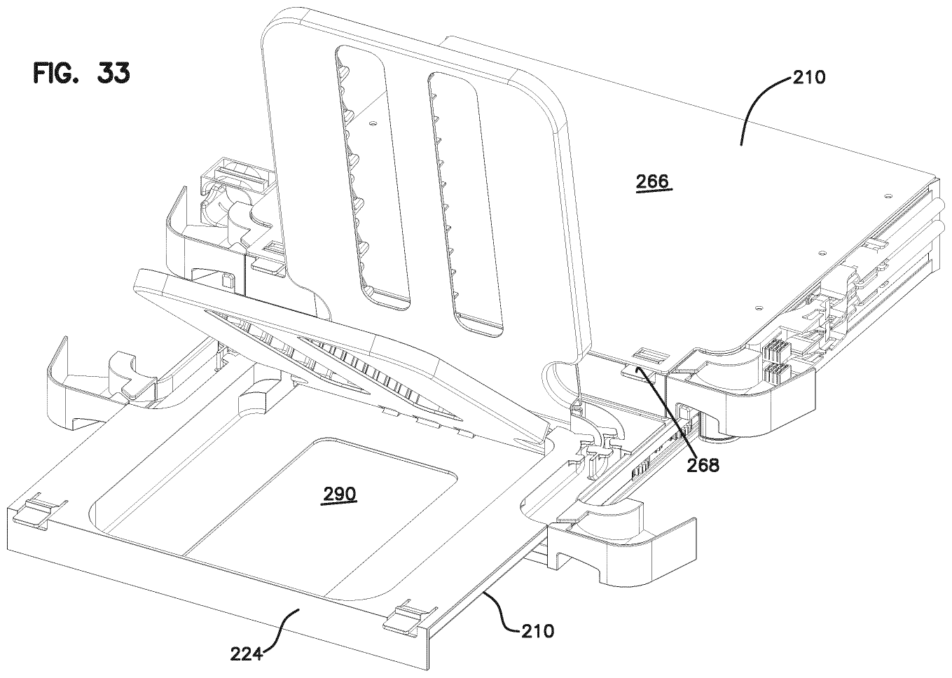

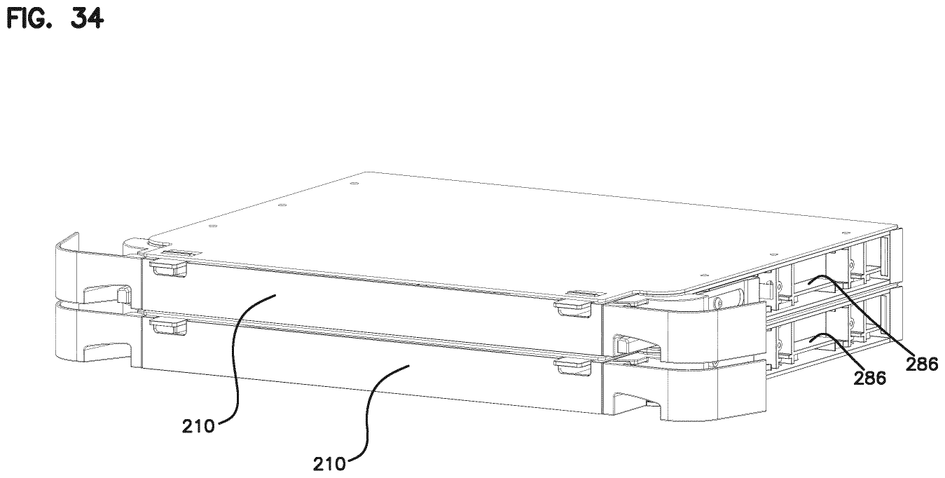

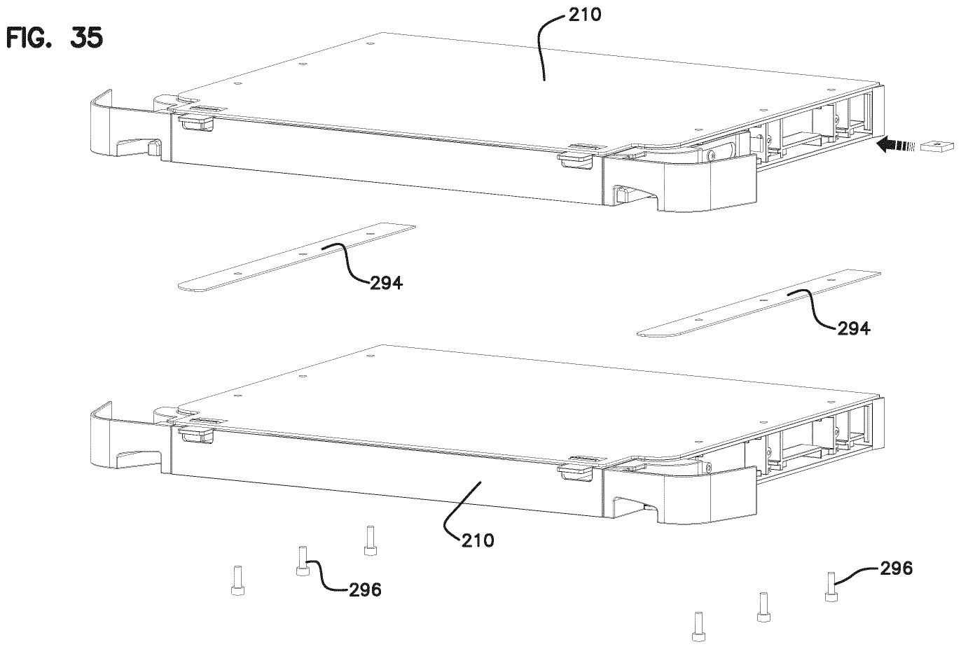

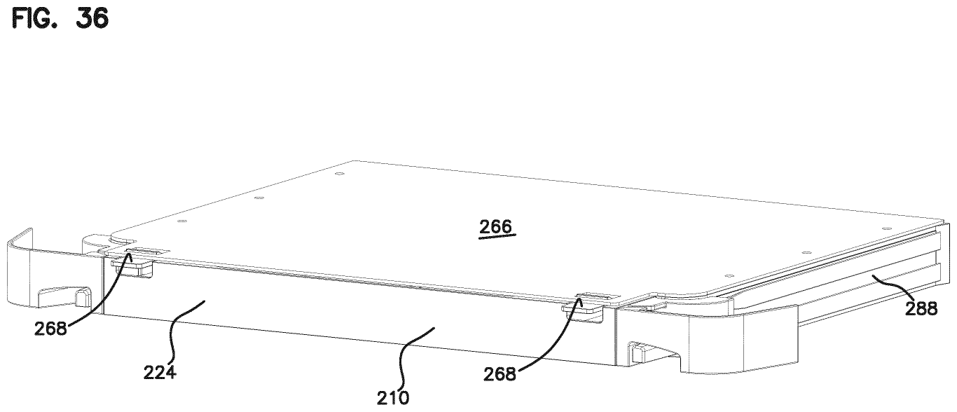

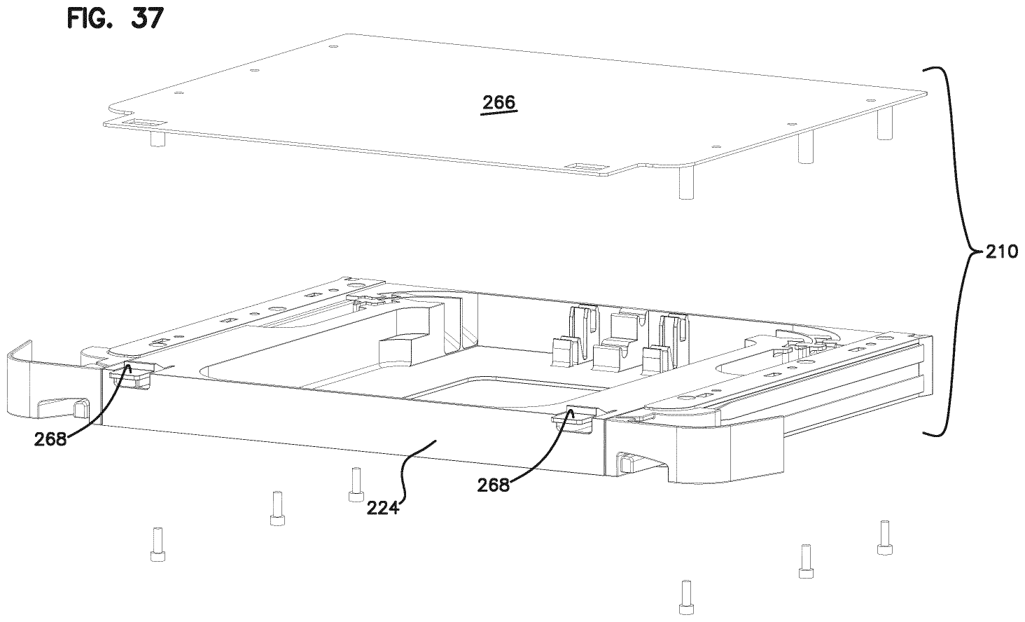

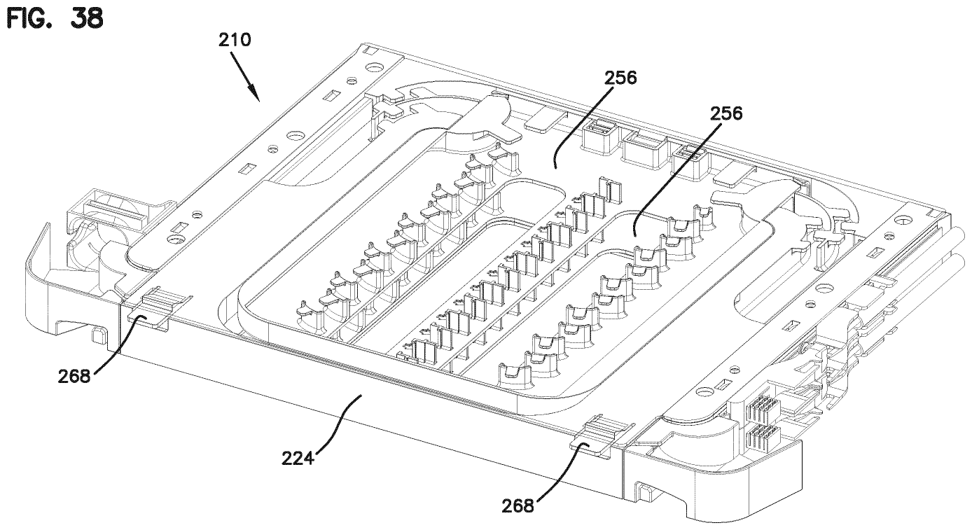

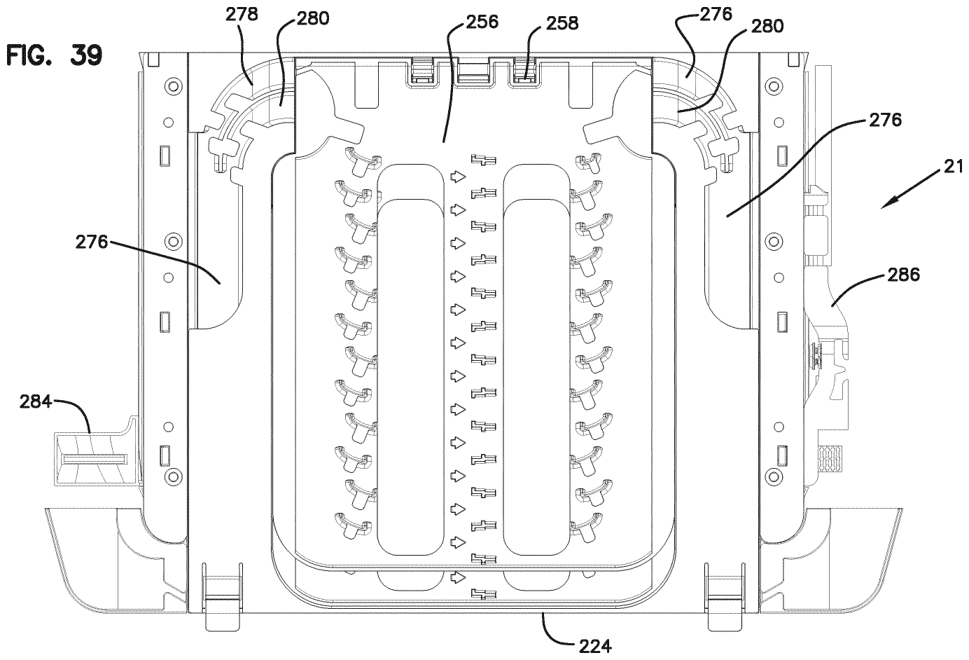

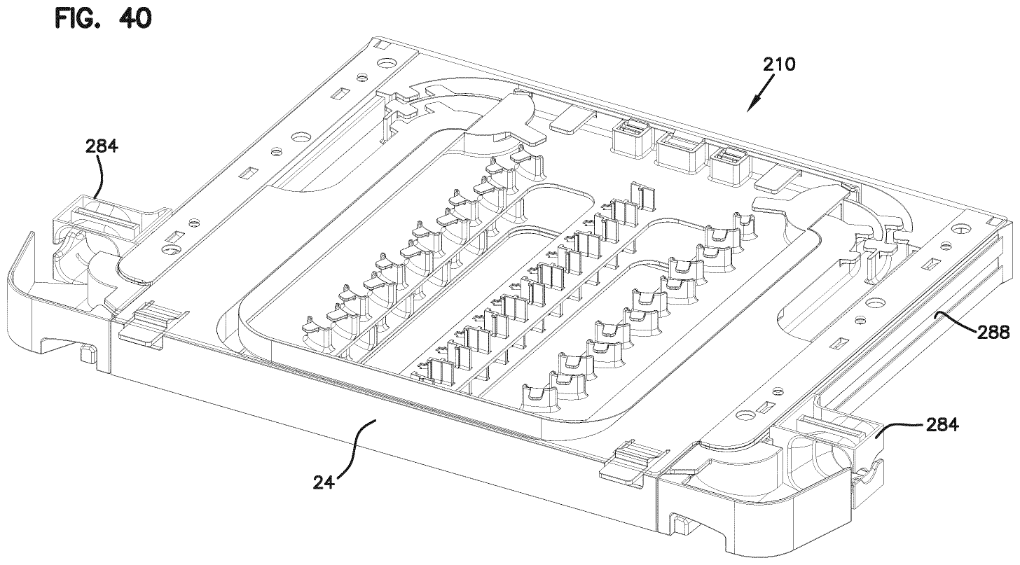

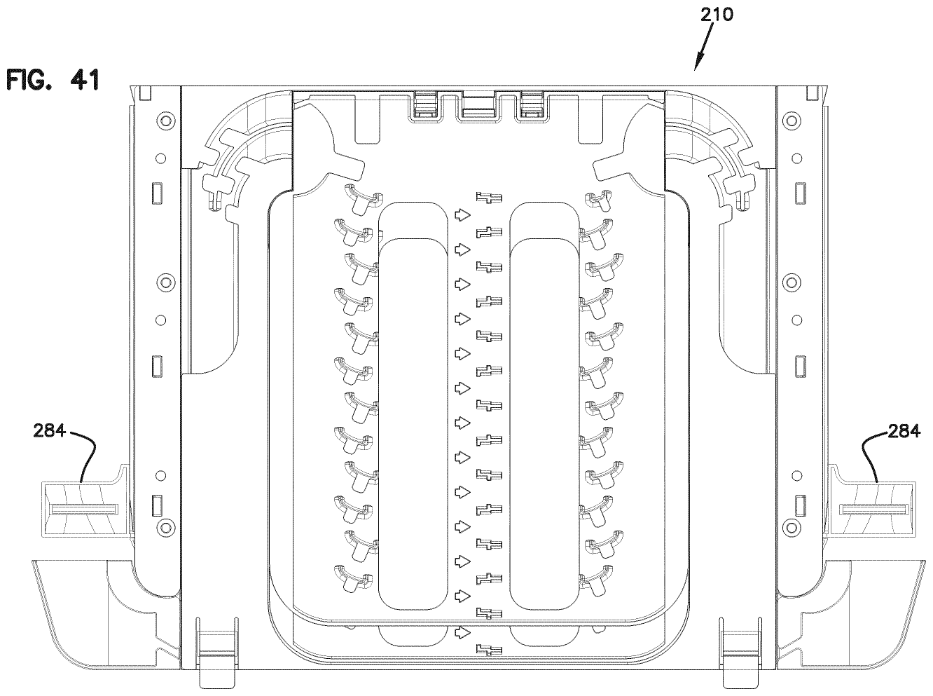

Referring now to FIGS. 30-41, various additional embodiments of elements 210 are shown. Element 210 includes a chassis 220 in a movable tray 224 mounted with a slide mechanism 230 which promotes synchronized movement of radius limiters 238. Each tray 224 includes two hingedly mounted frame members 256. Each frame member 256 has a middle portion 260 separated by openings 262 from side portions 264. Middle portion 260 can hold fiber terminations. Side portions 264 include radius limiters 270. Cover 266 goes over tray 224. Latches 268 latch tray 224 to cover 266 in the closed position.

A pathway 276 extends from either side from tray 224 to supply cables to each of trays 224. An upper level 278 and a lower level 280 supply the respective frame members 256 with cabling. A general S-shaped pathway 276 is defined wherein the pathway 276 passes close to hinges 258.

A dovetail 288 is used to hold cable mounts 286 and radius limiters 284.

An opening 290 in tray 224 allows for connector access by the technician. Similarly, openings 262 on each frame member 256 allow for technician access to the individual connectors.

To form a block 292 of plural elements 210, bars 294 and fasteners 296 are used. Bars 294 give a small spacing between each element 210.

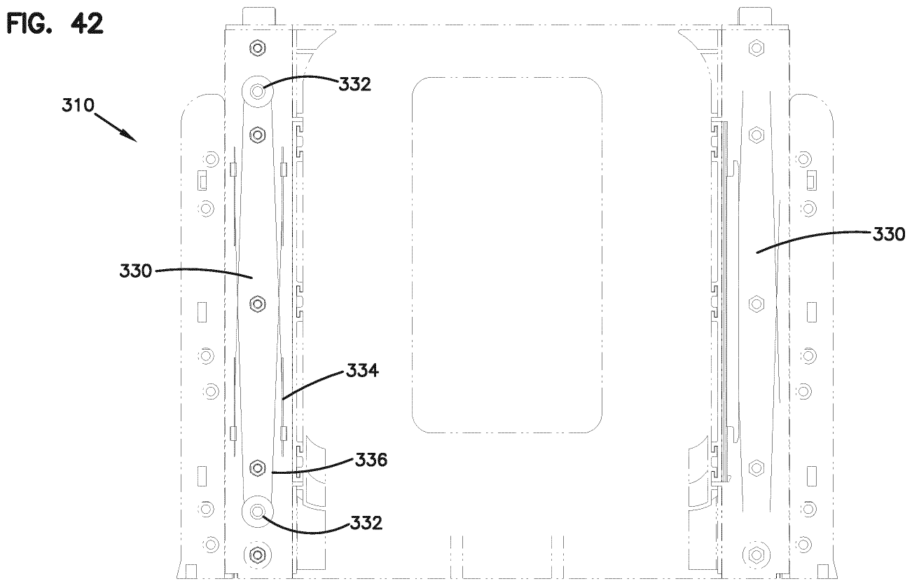

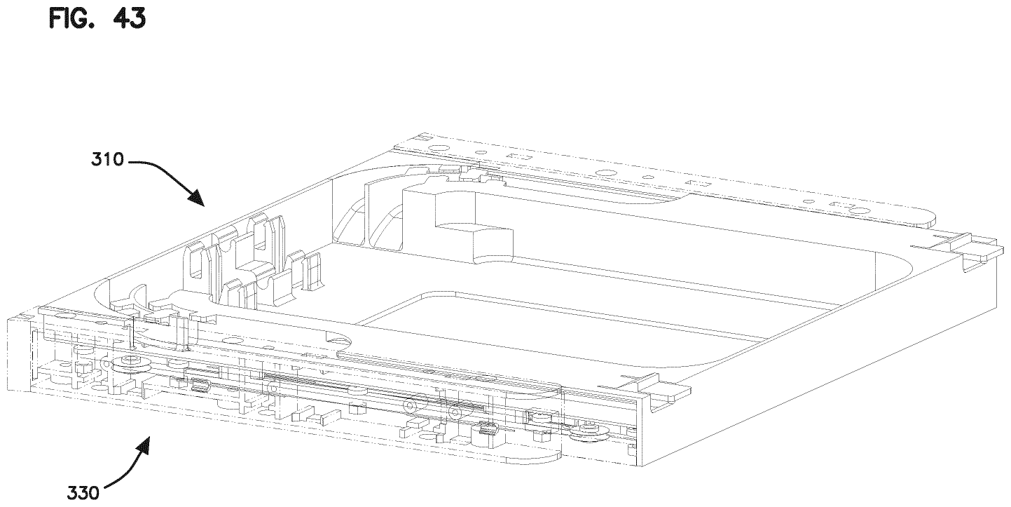

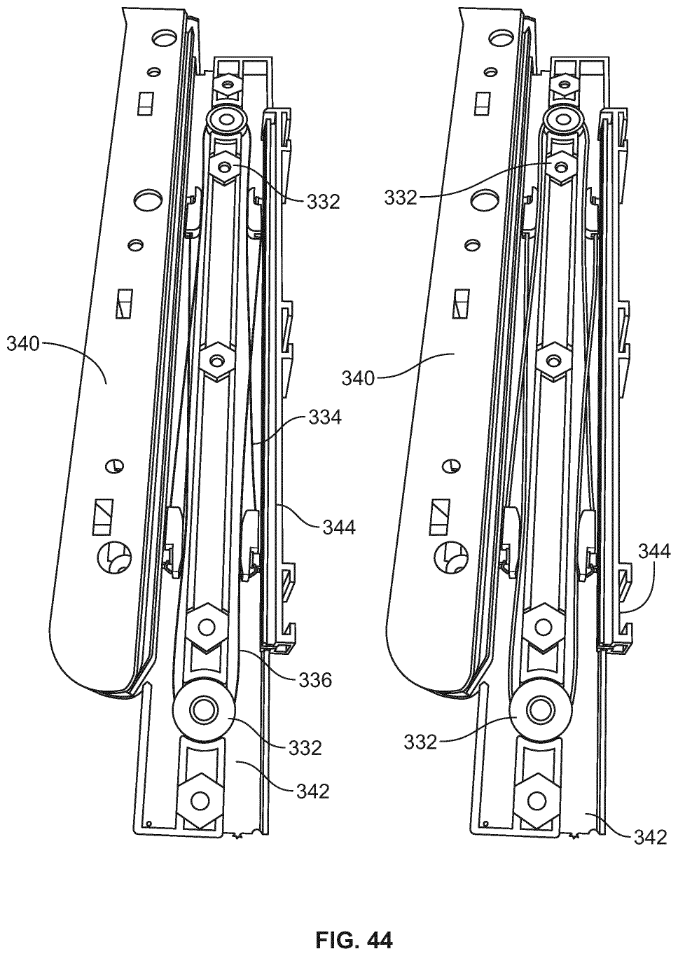

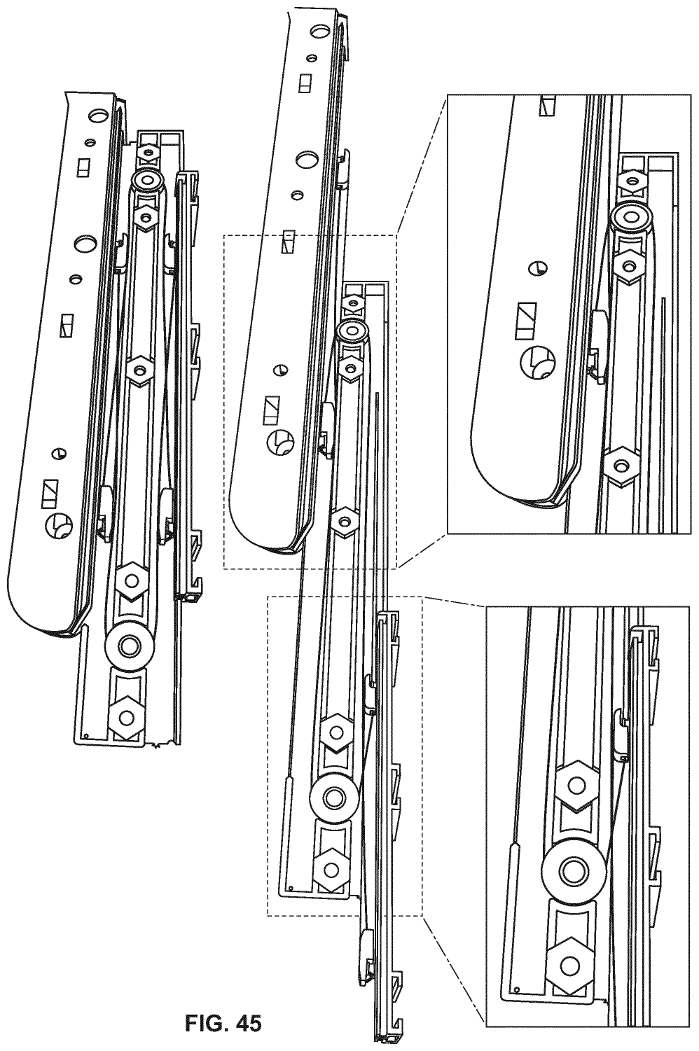

Referring now to FIGS. 42-45, an alternative slide mechanism 330 is shown in alternative element 310. Slide mechanism 330 allows for movement of the trays and related radius limiters and synchronized movement similar to slide mechanism 30, 230. Alternative slide mechanism 330 includes two wheels 332 and two wires 334, 336. The wheels 332 are located on second part 342. The wires are looped in opposite directions and are connected to the first part 340 and the third part 344.

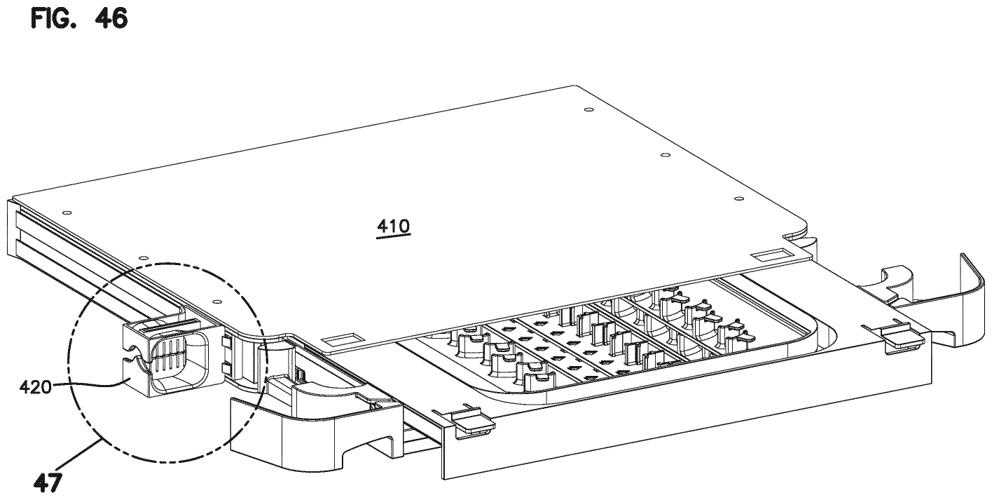

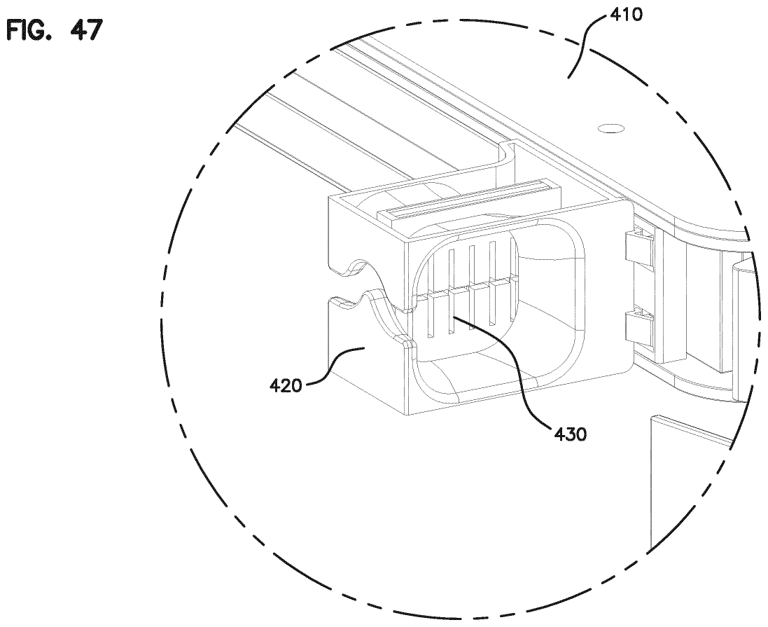

Referring now to FIGS. 46 and 47, an alternative radius limiter 420 is shown on alternative element 410. Radius limiter 420 includes friction members 430 which limit the amount of sliding movement of cables passing through radius limiter 420, to assist with cable management. Friction members 430 include flexible fingers which press lightly on the cables in radius limiter 420 to reduce or eliminate sliding movement of the cables in the radius limiter 420.

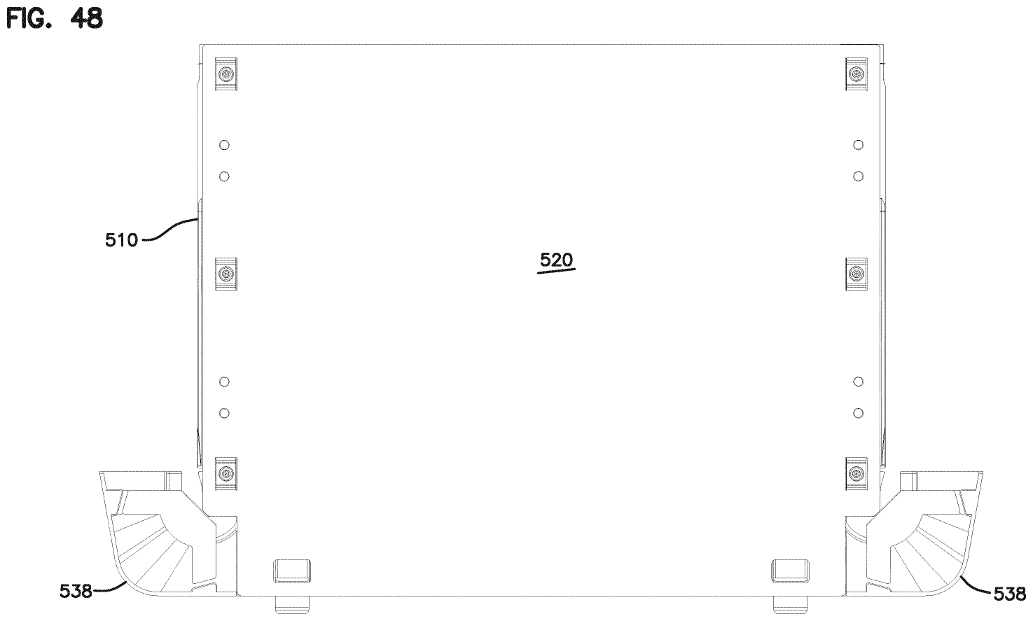

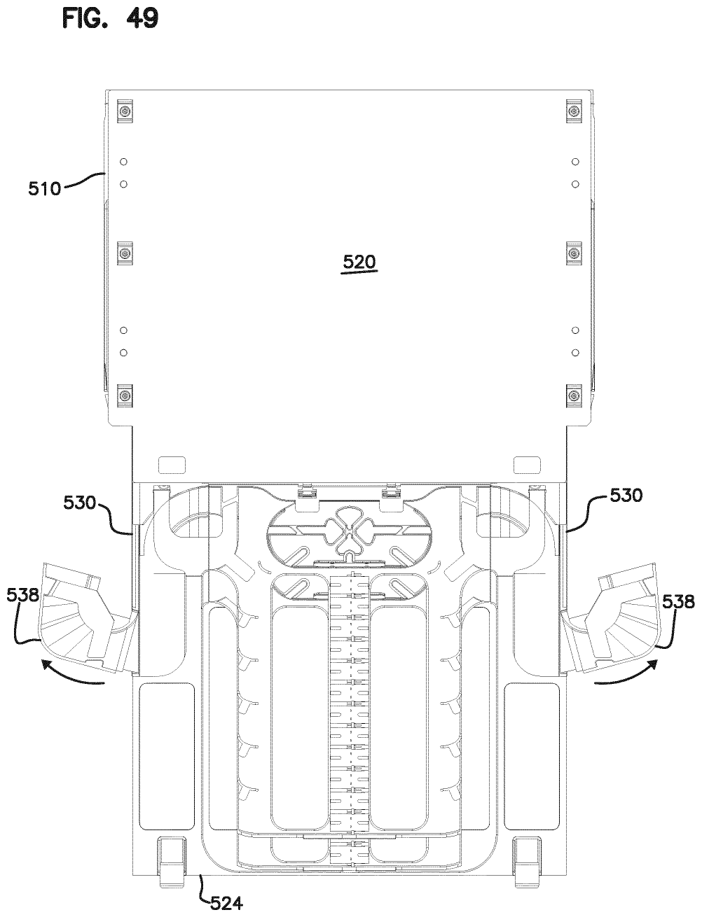

Referring now to FIGS. 48 and 49, an alternative element 510 is shown with a slide mechanism 530 which allows for synchronized movement of radius limiters 538 for cable management. Radius limiters 538 are also provided with a pivot feature to allow them to pivot rearwardly as the tray 524 is pulled out from chassis 520. Such rearward movement (pivot) allows for reduced pull on the cables, if pull is present, to allow the tray to be fully pulled out. Any angle can be provided. Fifteen degrees is one example angle.

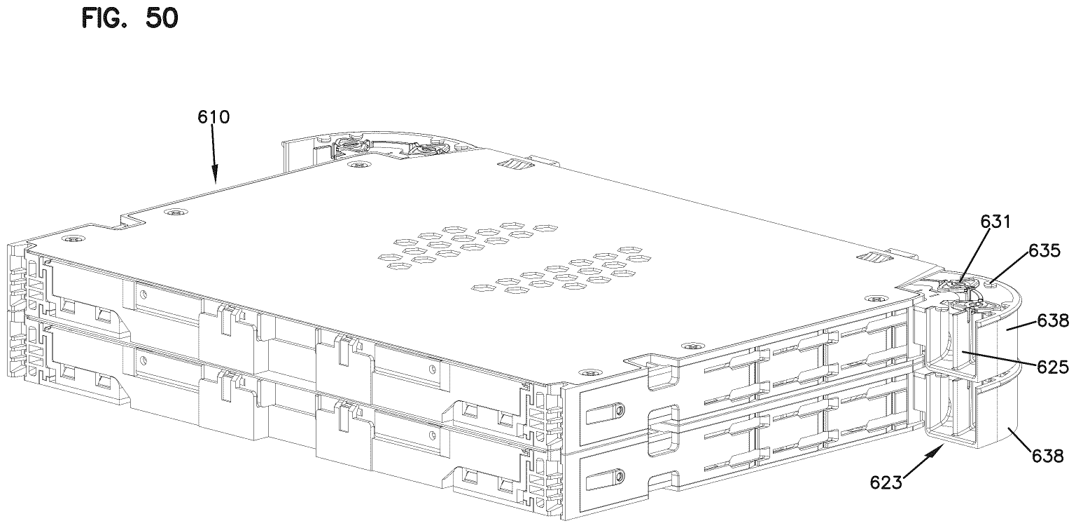

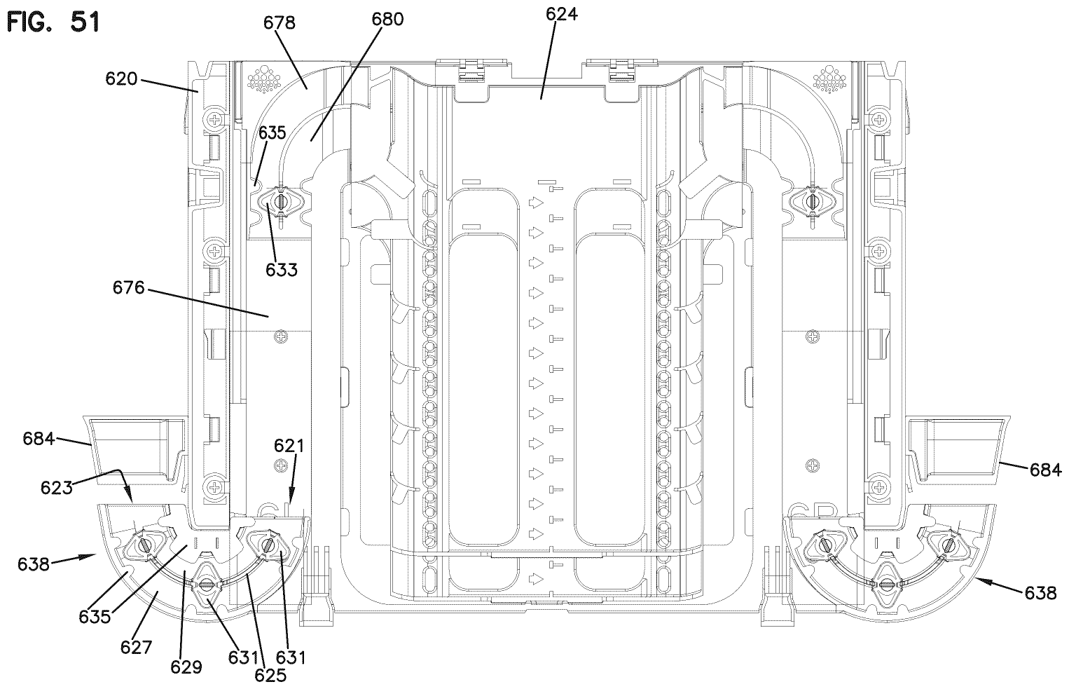

Referring now to FIGS. 50 and 51, an alternative radius limiter 638 is shown on the slide mechanisms of alternative elements 610. Elements 610 are generally similar in construction and function to those of the elements discussed previously. Radius limiter 638 defines a generally U-shaped configuration that leads cables from and to the element 610 while preserving minimum bend radius requirements.

The U-shaped radius limiter 638 defines an inner end 621 and an outer end 623 and a divider 625 extending from adjacent the inner end 621 to adjacent the outer end 623. According to one embodiment, the divider 625 does not extend all the way to the inner and outer ends 621, 623 of the U-shaped radius limiter 638. The outer end 623 of the radius limiter 638 cooperates with a cable guide 684 that is mounted to the chassis 620 of the element 610 for leading cables to and from the tray 624 of the element 610.

The divider 625 of the radius limiter 638 forms two separate troughs 627, 629 for the radius limiter 638. The two troughs 627, 629 isolate and separate the cables (e.g., coming in and going out) of the element 610 into two distinct paths. According to one example cable routing configuration, the two troughs 627, 629 may guide the cables to the upper and lower levels 678, 680 defined toward the rear of the tray 624 while maintaining the S-shaped pathway 676 created within the element 610. The divider 625 of the radius limiter 638 includes a plurality of cable management tabs 631 mounted thereon for retaining the cables within the troughs 627, 629. A similar tab 633 is also found at the rear of the tray 624 for retaining the cables that are being lead to the upper and lower levels 678, 680. The tabs 631 and 633 may be removable, snap-on structures.

The tabs 631 and 633 cooperate with additional cable management fingers 635 defined both on the radius limiter 638 and toward the rear of the tray 624 in retaining the cables within the S-shaped pathway 676.

### PARTS LIST

10 element
12 block
20 chassis
24 tray
30 slide mechanism
32 gears
34 rack
36 entry points
38 radius limiters
50 mounting structure
52 adapters
56 T-shaped frame member
58 hinge
62 top frame member
64 bottom frame member
70 adapter blocks
72 connectors
74 cables
76 pathway
78 upper level
80 lower level
84 portion
86 flanges
90 radius limiters
96 openings
100 cable mount
102 cable wrap
106 radius limiters
210 element
220 chassis
224 tray
230 slide mechanism
238 radius limiters
256 frame members
258 hinges
260 middle portion
262 openings
264 side portions
266 cover
268 latches
270 radius limiters
276 pathway
278 upper level
280 lower level
284 radius limiters
286 cable mounts
288 dovetail
290 opening
292 block
294 bar
296 fasteners
310 element
330 slide mechanism
332 wheels
334 wire
336 wire
340 first part
342 second part
344 third part
410 element
420 radius limiter
430 friction members
510 element
520 chassis
524 tray
530 slide mechanism
538 radius limiters
610 element
620 chassis
621 inner end of radius limiter
623 outer end of radius limiter
624 tray
625 divider
627 trough
629 trough
631 cable management tab
633 cable management tab
635 cable management finger
638 radius limiter
676 pathway
678 upper level
680 lower level
684 cable guide

1-11. (canceled)

12. An optical fiber distribution rack comprising:
a plurality of optical fiber distribution elements mounted in a stacked arrangement along a column to the optical fiber distribution rack, each optical fiber distribution element comprising:
a chassis defining an interior;
a tray movable along a front-to-back direction relative to the chassis, wherein the tray is slidably movable from within the chassis to a position at least partially outside the chassis, the tray defining a bottom wall;
a slide mechanism, which connects the movable tray to the chassis, wherein the slide mechanism includes a radius limiter defining a U-shaped cable-management wall which moves with synchronized movement relative to the chassis and the tray during slidable movement of the tray, wherein the entire radius limiter moves linearly along the front-to-back direction relative to both the chassis and the tray during slidable movement of the tray;
wherein a cable entering or exiting the movable tray follows an S-shaped pathway as the cable extends from an exterior of the movable tray toward the movable radius limiter in a first direction, winds around the U-shaped cable-management wall of the movable radius limiter in a second direction generally opposite the first direction, and is routed back within the tray in a third direction generally opposite the second direction, wherein the first, second, and third directions are generally parallel to a direction taken along the front-to-back direction;
wherein the tray further includes at least one fixed radius limiter that is molded integrally with the bottom wall of the tray, wherein the at least one fixed radius limiter defines a curved surface for guiding the cable entering or exiting the movable tray.

13. The optical fiber distribution rack of claim 12, wherein the tray of each optical fiber distribution element includes an array of adapters that are stacked within the tray front to back along a line which is generally parallel to the direction of travel of the movable tray.

14. The optical fiber distribution rack of claim 13, wherein the adapters of the array of adapters are removably mounted within the tray.

15. The optical fiber distribution rack of claim 13, wherein the array of adapters are generally stacked along a center line bisecting the tray.

16. The optical fiber distribution rack of claim 13, wherein the tray of each optical fiber distribution element includes at least one hingedly mounted frame member which hinges about an axis perpendicular to the direction of travel of the movable tray, wherein the array of adapters are provided on the at least one hingedly mounted frame member.

17. The optical fiber distribution rack of claim 16, wherein the tray of each optical fiber distribution element includes two frame members hingedly mounted for independent movement and the S-shaped pathway includes an upper portion and a lower portion for leading cables to and from the two frame members.

18. The optical fiber distribution rack of claim 17, wherein the movable radius limiter of the slide mechanism defines a divider for separating and guiding cables to and/or from the upper portion and the lower portion of the S-shaped pathway.

19. The optical fiber distribution rack of claim 12, wherein at least one of the optical fiber distribution elements further comprises a cable mount along a side of the chassis.

20. The optical fiber distribution rack of claim 12, wherein at least one of the optical fiber distribution elements further comprises another non-movable cable radius limiter along a side of the chassis.

21. The optical fiber distribution rack of claim 12, wherein the tray of each optical fiber distribution element includes a plurality of fixed radius limiters that are molded integrally with the bottom wall of the tray, wherein each fixed radius limiter defines a curved surface for guiding a cable entering or exiting the movable tray.

22. The optical fiber distribution rack of claim 12, wherein the at least one fixed radius limiter includes laterally extending flanges for retaining cabling against the curved surface of the at least one fixed radius limiter.

23. The optical fiber distribution rack of claim 21, wherein each of the plurality of fixed radius limiters includes laterally extending flanges for retaining cabling against the curved surfaces of the fixed radius limiters.

24. The optical fiber distribution rack of claim 12, wherein the tray of each optical fiber distribution element defines a pull handle at a front of the tray that is molded integrally with the tray for providing a grip surface to allow the tray to be slidably moved.

25. The optical fiber distribution rack of claim 24, wherein the tray of each optical fiber distribution element defines a pair of pull handles that are molded integrally with the tray for providing grip surfaces, wherein the pull handles are provided at the front of the tray on right and left sides.

26. The optical fiber distribution rack of claim 13, wherein the array of adapters that are stacked within the tray define at least twelve adapters.

27. An optical fiber distribution rack comprising:
a plurality of optical fiber distribution elements mounted in a stacked arrangement along a column to the optical fiber distribution rack, each optical fiber distribution element comprising:
a chassis;
a tray slidably movable with respect to the chassis along a direction of movement; and
a slide mechanism, which connects the movable tray to the chassis, wherein the slide mechanism includes a radius limiter which moves with synchronized movement relative to the chassis and the tray during slidable movement of the tray;
wherein the tray includes at least one frame member that includes a frame member hinge that is coupled to a tray hinge of the tray, wherein the frame member hinge and the tray hinge are configured to, and cooperate to, allow the at least one frame member to pivot with respect to the tray about an axis perpendicular to the direction of movement of the movable tray such that the at least one frame member can be pivotally lifted and a bottom of the at least one frame member can be accessed;
wherein a cable entering or exiting the movable tray is routed around the radius limiter.

28. The optical fiber distribution rack of claim 27, wherein the tray of each optical fiber distribution element includes two frame members hingedly mounted for independent movement.

29. The optical fiber distribution rack of claim 27, wherein at least one of the optical fiber distribution elements further comprises a cable mount along a side of the chassis.

30. The optical fiber distribution rack of claim 27, wherein at least one of the optical fiber distribution elements further comprises another non-movable cable radius limiter along a side of the chassis.

31. The optical fiber distribution rack of claim 27, wherein the radius limiter of the slide mechanism of at least one of the optical fiber distribution elements includes a rotatable portion that is configured to rotate rearwardly for cable management.

32. The optical fiber distribution rack of claim 27, wherein each frame member of the tray of each of the optical fiber distribution elements defines an array of adapters, each adapter defining ports for receiving connectors to be interconnected through the adapter.

33. The optical fiber distribution rack of claim 32, wherein each array of adapters defines a line which is generally parallel to the direction of movement of the movable tray.

34. The optical fiber distribution rack of claim 27, wherein the movable radius limiter defines a U-shaped configuration.

35. The optical fiber distribution rack of claim 27, wherein the cable entering or exiting the movable tray of each of the optical fiber distribution elements follows an S-shaped pathway as the cable extends from an exterior of the movable tray toward the movable radius limiter in a first direction, winds around the radius limiter in a second direction generally opposite the first direction, and is routed back within the at least one hingedly mounted frame member in a third direction generally opposite the second direction.

36. The optical fiber distribution rack of claim 35, wherein the S-shaped pathway includes an upper portion and a lower portion.

37. The optical fiber distribution rack of claim 36, wherein the radius limiter of the slide mechanism defines a divider for separating and guiding cables to and/or from the upper portion and the lower portion of the S-shaped pathway.
